(19) United States
(12) Patent Application Publication
(10) Pub. No.: US 2011/0237250 A1
(43) Pub. Date: Sep. 29, 2011

(54) MANAGEMENT OF ALLOWED CSG LIST AND VPLMN-AUTONOMOUS CSG ROAMING

(75) Inventors: Gavin Bernard Horn, La Jolla, CA (US); Osok Song, San Diego, CA (US); Ramachandran Subramanian, San Diego, CA (US)

(73) Assignee: QUALCOMM Incorporated, San Diego, CA (US)

(21) Appl. No.: 12/821,531

(22) Filed: Jun. 23, 2010

Related U.S. Application Data
(60) Provisional application No. 61/220,536, filed on Jun. 25, 2009.
(60) Provisional application No. 61/223,342, filed on Jul. 6, 2009.
(60) Provisional application No. 61/226,520, filed on Jul. 17, 2009.
(60) Provisional application No. 61/245,616, filed on Sep. 24, 2009.
(60) Provisional application No. 61/254,150, filed on Oct. 22, 2009.
(60) Provisional application No. 61/302,426, filed on Feb. 8, 2010.

(51) Int. Cl. H04W 8/02

(52) U.S. Cl. 455/433

(57) ABSTRACT

Systems and methodologies are described that facilitate supporting VPLMN-autonomous CSG roaming in a wireless communication environment. A UE can access a CSG list server associated with a VPLMN. A trust relation can be established between the UE and the CSG list server, for example. Moreover, the CSG list server can update a VPLMN allowed CSG list associated with the VPLMN stored by the UE. Hence, the UE can receive the VPLMN allowed CSG list from the CSG list server associated with the VPLMN. Further, the UE can store the VPLMN allowed CSG list as part of an allowed CSG list. The VPLMN allowed CSG list can include one or more entries associated with the VPLMN. Moreover, the allowed CSG list can be under control of at least one operator and the UE.

Claim of Priority under 35 U.S.C. §119

The present Application for Patent claims priority to Provisional application No. 61/220,536, entitled “MANAGEMENT OF OPERATOR CSG LIST AND VPLMN-AUTONOMOUS CSG ROAMING” filed Jun. 25, 2009; Provisional application No. 61/223,342, entitled “MANAGEMENT OF OPERATOR CSG LIST AND VPLMN-AUTONOMOUS CSG ROAMING” filed Jul. 6, 2009; Provisional application No. 61/226,520, entitled “MANAGEMENT OF OPERATOR CSG LIST AND VPLMN-AUTONOMOUS CSG ROAMING” filed Jul. 17, 2009; Provisional application No. 61/245,616, entitled “MANAGEMENT OF OPERATOR CSG LIST AND VPLMN-AUTONOMOUS CSG ROAMING” filed Sep. 24, 2009; Provisional application No. 61/254,150, entitled “MANAGEMENT OF OPERATOR CSG LIST AND VPLMN-AUTONOMOUS CSG ROAMING” filed Oct. 22, 2009; and Provisional application No. 61/302,426, entitled “MANAGEMENT OF OPERATOR CSG LIST AND VPLMN-AUTONOMOUS CSG ROAMING” filed Feb. 8, 2010. The aforementioned Provisional Applications are assigned to the assignee hereof and hereby expressly incorporated by reference herein.

### BACKGROUND

1. Field

The following description relates generally to wireless communications, and more particularly to supporting Visited Public Land Mobile Network (VPLMN)-autonomous Closed Subscriber Group (CSG) roaming in a wireless communication environment.

2. Background

Wireless communication systems are widely deployed to provide various types of communication content such as, for example, voice, data, and so on. Typical wireless communication systems can be multiple-access systems capable of supporting communication with multiple users by sharing available system resources (e.g., bandwidth, transmit power, . . . ). Examples of such multiple-access systems can include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), and/or multi-carrier wireless specifications such as evolution data optimized (EV-DO), one or more revisions thereof, etc.

Generally, wireless multiple-access communication systems can simultaneously support communication for multiple user equipments (UEs). Each UE can communicate with one or more base stations via transmissions on forward and reverse links. The forward link (or downlink) refers to the communication link from base stations to UEs, and the reverse link (or uplink) refers to the communication link from UEs to base stations. Further, communications between UEs and base stations can be established via single-input single-output (SISO) systems, multiple-input single-output (MISO) systems, multiple-input multiple-output (MIMO) systems, and so forth. In addition, UEs can communicate with other UEs (and/or base stations with other base stations) in peer-to-peer wireless network configurations.

Heterogeneous wireless communication systems commonly can include various types of base stations, each of which can be associated with differing cell sizes. For instance, macro cell base stations typically leverage antenna(s) installed on masts, rooftops, other existing structures, or the like. Further, macro cell base stations oftentimes have power outputs on the order of tens of watts, and can provide coverage for large areas. The femto cell base station is another class of base station that has recently emerged. Femto cell base stations are commonly designed for residential or small business environments, and can provide wireless coverage to UEs using a wireless technology (e.g., 3GPP Universal Mobile Telecommunications System (UMTS) or Long Term Evolution (LTE), 1x Evolution-Data Optimized (1xEV-DO), . . . ) to communicate with the UEs and an existing broadband Internet connection (e.g., digital subscriber line (DSL), cable, . . . ) for backhaul. A femto cell base station can also be referred to as a Home Evolved Node B (HeNB), a Home Node B (HNB), a femto cell, or the like. Examples of other types of base stations include pico cell base stations, micro cell base stations, and so forth.

In some scenarios, some femto cell base stations or other base stations in a network can be restricted for access in some manner. For example, different base stations in the network can belong to different Closed Subscriber Groups (CSGs). Further, a UE can use some form of list (e.g., whitelist, . . . ) to identify base stations that the UE is allowed to access. The list is oftentimes provisioned by a network.

A Public Land Mobile Network (PLMN) can be a network that is established and operated by an operator. In various situations, a UE can roam, where the UE can connect to a Visited Public Land Mobile Network (VPLMN) other than a PLMN to which the UE is directly subscribed. Further, the PLMN to which the UE is directly subscribed can be referred to as a Home Public Land Mobile Network (HPLMN). Conventional approaches typically fail to address how the list used to identify base stations that the UE is allowed to access is provisioned when the UE connects to a VPLMN.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more embodiments and corresponding disclosure thereof, various aspects are described in connection with facilitating support of VPLMN-autonomous CSG roaming in a wireless communication environment. A UE can access a CSG list server associated with a VPLMN. A trust relation can be established between the UE and the CSG list server, for example. Moreover, the CSG list server can update a VPLMN allowed CSG list associated with the VPLMN stored by the UE. Hence, the UE can receive the VPLMN allowed CSG list from the CSG list server associated with the VPLMN. Further, the UE can store the VPLMN allowed CSG list as part of an allowed CSG list. The VPLMN allowed CSG list can include one or more entries associated with the VPLMN. Moreover, the allowed CSG list can be under control of at least one operator and the UE.

According to related aspects, a method is described herein. The method can include accessing a Closed Subscriber Group (CSG) list server associated with a Visited Public Land Mobile Network (VPLMN). Further, the method can include receiving a VPLMN allowed CSG list from the CSG list server associated with the VPLMN. Moreover, the method can include storing the VPLMN allowed CSG list as part of an allowed CSG list at a user equipment (UE) to provision the UE in the VPLMN, the VPLMN allowed CSG list comprises one or more entries associated with the VPLMN and the allowed CSG list being under control of at least one operator and the UE.

Another aspect relates to a wireless communications apparatus. The wireless communications apparatus can include at least one processor. The at least one processor can be configured to access a Closed Subscriber Group (CSG) list server associated with a Visited Public Land Mobile Network (VPLMN). Moreover, the at least one processor can be configured to receive a VPLMN allowed CSG list from the CSG list server associated with the VPLMN. Further, the at least one processor can be configured to store the VPLMN allowed CSG list as part of an allowed CSG list at a user equipment (UE) to provision the UE in the VPLMN, the VPLMN allowed CSG list comprises one or more entries associated with the VPLMN and the allowed CSG list being under control of at least one operator and the UE.

Yet another aspect relates to an apparatus. The apparatus can include means for accessing a Closed Subscriber Group (CSG) list server associated with a Visited Public Land Mobile Network (VPLMN). The apparatus can further include means for receiving a VPLMN allowed CSG list from the CSG list server associated with the VPLMN. Moreover, the apparatus can include means for storing the VPLMN allowed CSG list as part of an allowed CSG list at a user equipment (UE) to provision the UE in the VPLMN, the VPLMN allowed CSG list comprises one or more entries associated with the VPLMN and the allowed CSG list being under control of at least one operator and the UE.

Still another aspect relates to a computer program product that can comprise a computer-readable medium. The computer-readable medium can include code for causing at least one computer to access a Closed Subscriber Group (CSG) list server associated with a Visited Public Land Mobile Network (VPLMN). Moreover, the computer-readable medium can include code for causing at least one computer to receive a VPLMN allowed CSG list from the CSG list server associated with the VPLMN. Further, the computer-readable medium can include code for causing at least one computer to store the VPLMN allowed CSG list as part of an allowed CSG list at a user equipment (UE) to provision the UE in the VPLMN, the VPLMN allowed CSG list comprises one or more entries associated with the VPLMN and the allowed CSG list being under control of at least one operator and the UE.

Yet another aspect relates to an apparatus that can include an access component that accesses a Closed Subscriber Group (CSG) list server associated with a Visited Public Land Mobile Network (VPLMN). Moreover, the apparatus can include a list management component that receives a VPLMN allowed CSG list from the CSG list server associated with the VPLMN, and stores the VPLMN allowed CSG list as part of an allowed CSG list at a user equipment (UE) to provision the UE in the VPLMN, the VPLMN allowed CSG list comprises one or more entries associated with the VPLMN and the allowed CSG list being under control of at least one operator and the UE.

In accordance with other aspects, a method is described herein. The method can include establishing a trust relation with a user equipment (UE) associated with a different Public Land Mobile Network (PLMN). Moreover, the method can include updating a Visited Public Land Mobile Network (VPLMN) allowed Closed Subscriber Group (CSG) list associated with a VPLMN stored by the UE, the VPLMN allowed CSG list being a part of an allowed CSG list under control of at least one operator and the UE.

Another aspect relates to a wireless communications apparatus. The wireless communications apparatus can include at least one processor. The at least one processor can be configured to establish a trust relation with a user equipment (UE) associated with a different Public Land Mobile Network (PLMN). Further, the at least one processor can be configured to update a Visited Public Land Mobile Network (VPLMN) allowed Closed Subscriber Group (CSG) list associated with a VPLMN stored by the UE, the VPLMN allowed CSG list being a part of an allowed CSG list under control of at least one operator and the UE.

Yet another aspect relates to an apparatus. The apparatus can include means for establishing a trust relation with a user equipment (UE) associated with a different Public Land Mobile Network (PLMN). Moreover, the apparatus can include means for updating a Visited Public Land Mobile Network (VPLMN) allowed Closed Subscriber Group (CSG) list associated with a VPLMN stored by the UE, the VPLMN allowed CSG list being a part of an allowed CSG list under control of at least one operator and the UE.

Still another aspect relates to a computer program product that can comprise a computer-readable medium. The computer-readable medium can include code for causing at least one computer to establish a trust relation with a user equipment (UE) associated with a different Public Land Mobile Network (PLMN). Further, the computer-readable medium can include code for causing at least one computer to update a Visited Public Land Mobile Network (VPLMN) allowed Closed Subscriber Group (CSG) list associated with a VPLMN stored by the UE, the VPLMN allowed CSG list being a part of an allowed CSG list under control of at least one operator and the UE.

Yet another aspect relates to an apparatus that can include an initialization component that establishes a trust relation with a user equipment (UE) associated with a different Public Land Mobile Network (PLMN). Moreover, the apparatus can include an update component that updates a Visited Public Land Mobile Network (VPLMN) allowed Closed Subscriber Group (CSG) list associated with a VPLMN stored by the UE, the VPLMN allowed CSG list being a part of an allowed CSG list under control of at least one operator and the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is an illustration of a wireless communication system in accordance with various aspects set forth herein.

FIG. 2 is an illustration of an example system that supports VPLMN- autonomous CSG roaming in a wireless communication environment.

FIG. 3 is an illustration of an example system that provisions an allowed CSG list and an operator CSG list in a wireless communication environment that supports VPLMN-autonomous CSG roaming

FIG. 4 is an illustration of an example system that provisions an allowed CSG list and an operator CSG list in a wireless communication environment that supports VPLMN-autonomous CSG roaming

FIG. 5 is an illustration of an example system that controls access in a wireless communication environment.

FIG. 6 is an illustration of an example system that manages CSG subscription data at a UE in a wireless communication environment.

FIG. 7 is an illustration of an example system that enables deployment of access point base stations (e.g., femto cell base stations, . . . ) within a network environment.

FIG. 8 is an illustration of an example system that provides Closed Subscriber Group (CSG) support in a wireless communication environment.

FIG. 9 is an illustration of an example methodology that facilitates collecting CSG subscription data in a wireless communication environment to provide VPLMN-autonomous CSG roaming support.

FIG. 10 is an illustration of an example methodology that facilitates provisioning an allowed CSG list in a wireless communication environment to provide VPLMN-autonomous CSG roaming support.

FIG. 11 is an illustration of an example methodology that facilitates provisioning CSG subscription data in a wireless communication environment.

FIG. 12 is an illustration of an example methodology that facilitates retrieving CSG subscription data in a wireless communication environment.

FIG. 13 is an illustration of an example system that enables obtaining CSG subscription data in a wireless communication environment.

FIG. 14 is an illustration of an example system that enables provisioning CSG subscription data in a wireless communication environment.

FIGS. 15-16 are illustrations of example systems that can be utilized to implement various aspects of the functionality described herein.

FIG. 17 is an illustration of an example wireless network environment that can be employed in conjunction with various systems and methods described herein.

### DETAILED DESCRIPTION

Various aspects of the claimed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspects(s) may be practiced without these specific details. In other instances, well-known structures and devices are shown in block diagram form in order to facilitate describing one or more aspects.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an integrated circuit, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Various techniques described herein can be used for various wireless communication systems, such as code division multiple access (CDMA) systems, time division multiple access (TDMA) systems, frequency division multiple access (FDMA) systems, orthogonal frequency division multiple access (OFDMA) systems, single carrier-frequency division multiple access (SC-FDMA) systems, and other such systems. The terms “system” and “network” are often used interchangeably. A CDMA system can implement a radio technology such as Universal Terrestrial Radio Access (UTRA), CDMA2000, etc. UTRA includes Wideband-CDMA (W-CDMA) and other variants of CDMA. CDMA2000 covers IS-2000, IS-95, and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, CDMA2000 and UMB are described in documents from an organization named “3rd Generation Partnership Project 2” (3GPP2). Further, such wireless communication systems can additionally include peer-to-peer (e.g., mobile-to-mobile) ad hoc network systems often using unpaired unlicensed spectrums, 802.xx wireless LAN, BLUETOOTH and any other short- or long- range, wireless communication techniques.

Single carrier frequency division multiple access (SC-FDMA) utilizes single carrier modulation and frequency domain equalization. SC-FDMA has similar performance and essentially the same overall complexity as those of an OFDMA system. A SC-FDMA signal has lower peak-to-average power ratio (PAPR) because of its inherent single carrier structure. SC-FDMA can be used, for instance, in uplink communications where lower PAPR greatly benefits UEs in terms of transmit power efficiency. Accordingly, SC-FDMA can be implemented as an uplink multiple access scheme in 3GPP Long Term Evolution (LTE) or Evolved UTRA.

Furthermore, various aspects are described herein in connection with a user equipment (UE). A UE can refer to a device providing voice and/or data connectivity. A UE can be connected to a computing device such as a laptop computer or desktop computer, or it can be a self-contained device such as a personal digital assistant (PDA). A UE can also be called a system, subscriber unit, subscriber station, mobile station, mobile, remote station, remote terminal, mobile device, user terminal, terminal, wireless communication device, user agent, user device, or access terminal A UE can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various aspects are described herein in connection with a base station. A base station can be utilized for communicating with UE(s) and can also be referred to as an access point, Node B, Evolved Node B (eNodeB, eNB), a femto cell, a pico cell, a micro cell, a macro cell, a Home Evolved Node B (HeNB), a Home Node B (HNB), or some other terminology. A base station can refer to a device in an access network that communicates over the air interface, through one or more sectors, with UEs. The base station can act as a router between the wireless terminal and the rest of the access network, which can include an Internet Protocol (IP) network, by converting received air interface frames to IP packets. The base station can also coordinate management of attributes for the air interface.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Moreover, various functions described herein can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc (BD), where disks usually reproduce data magnetically and discs reproduce data optically with lasers. Combinations of the above should also be included within the scope of computer-readable media.

Various aspects will be presented in terms of systems that can include a number of devices, components, modules, and the like. It is to be understood and appreciated that the various systems can include additional devices, components, modules, etc. and/or one or more of the devices, components, modules etc. discussed in connection with the figures need not be included. A combination of these approaches can also be used.

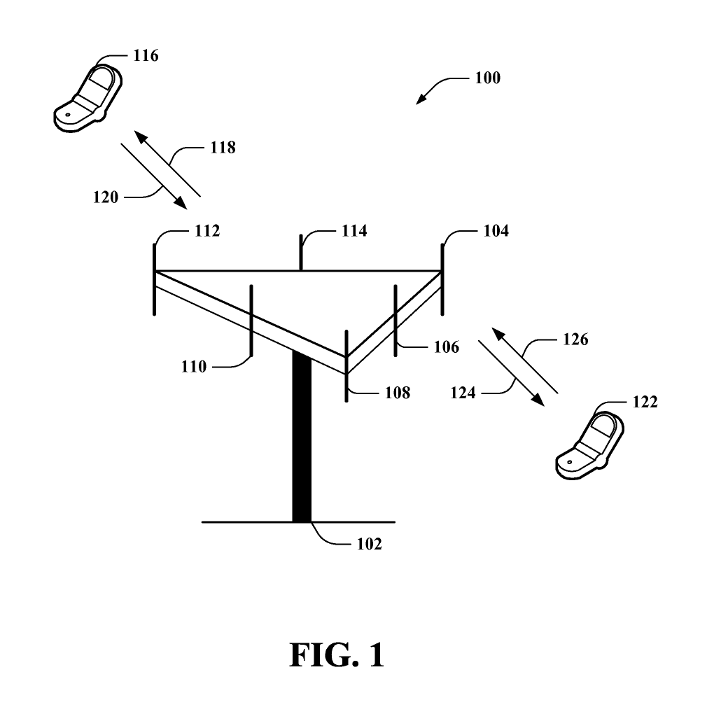

Referring now to FIG. 1, a wireless communication system 100 is illustrated in accordance with various embodiments presented herein. Wireless communication system 100 comprises a base station 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. Base station 102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 can communicate with one or more user equipments (UEs) such as UE 116 and UE 122; however, it is to be appreciated that base station 102 can communicate with substantially any number of UEs similar to UEs 116 and 122. UEs 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, UE 116 is in communication with antennas 112 and 114, where antennas 112 and 114 transmit information to UE 116 over a forward link 118 and receive information from UE 116 over a reverse link 120. Moreover, UE 122 is in communication with antennas 104 and 106, where antennas 104 and 106 transmit information to UE 122 over a forward link 124 and receive information from UE 122 over a reverse link 126. In a frequency division duplex (FDD) system, forward link 118 can utilize a different frequency band than that used by reverse link 120, and forward link 124 can employ a different frequency band than that employed by reverse link 126, for example. Further, in a time division duplex (TDD) system, forward link 118 and reverse link 120 can utilize a common frequency band and forward link 124 and reverse link 126 can utilize a common frequency band.

Each group of antennas and/or the area in which they are designated to communicate can be referred to as a sector of base station 102. For example, antenna groups can be designed to communicate to UEs in a sector of the areas covered by base station 102. In communication over forward links 118 and 124, the transmitting antennas of base station 102 can utilize beamforming to improve signal-to-noise ratio of forward links 118 and 124 for UEs 116 and 122. Also, while base station 102 utilizes beamforming to transmit to UEs 116 and 122 scattered randomly through an associated coverage, UEs in neighboring cells can be subject to less interference as compared to a base station transmitting through a single antenna to all its UEs.

Base station 102 can be part of a Public Land Mobile Network (PLMN). For instance, a UE (e.g., UE 116, UE 122, . . . ) can be directly subscribed to the PLMN associated with base station 102; thus, the PLMN associated with base station 102 can be referred to as a Home Public Land Mobile Network (HPLMN). According to another example, a UE (e.g., UE 116, UE 122, . . . ) can be directly subscribed to a disparate PLMN other than the PLMN associated with base station 102; hence, the PLMN associated with base station 102 can be referred to as a Visited Public Land Mobile Network (VPLMN).

Moreover, it is contemplated that base station 102 can be any type of base station (e.g., macro cell base station, micro cell base station, pico cell base station, femto cell base station, . . . ). Further, base station 102 can operate in closed access mode, for example. When employing closed access mode, base station 102 can operate as a Closed Subscriber Group (CSG) base station where a select group of users identified by a CSG Identifier (ID) are allowed to access such base station. It is to be appreciated, however, that the claimed subject matter is not so limited (e.g., base station 102 can operate in hybrid access mode, open access mode, . . . ).

A CSG base station refers to a base station with restricted association accessible by members of a CSG (e.g., non-accessible by non-members of the CSG, . . . ). A CSG base station can also be referred to as a closed base station. A CSG is a set of base stations that share a common access control list of UEs. Further, a CSG base station can advertise a corresponding CSG ID (e.g., CSG identity, . . . ), which specifies the CSG corresponding to the CSG base station.

Base station 102 can broadcast information to UE 116 and UE 122. The broadcasted information, for instance, can include a CSG ID that identifies a CSG associated with base station 102. A CSG ID is a binary based identifier associated with a subscriber group. The CSG ID can be used to identify a subscriber group (e.g., CSG, . . . ) associated with a CSG base station, and can be utilized to support restricted association for a CSG base station. The CSG ID can uniquely identify the CSG associated with the CSG base station; however, the claimed subject matter is not so limited. Further, the CSG ID associated with a base station typically is not based on an Internet Protocol (IP) address. It is also contemplated that more than one base station can share a common CSG ID; however, the claimed subject matter is not so limited.

As a UE (e.g., UE 116, UE 122, . . . ) roams throughout a network, the UE can use a list (e.g., whitelist, . . . ) stored by the UE to identify base stations that the UE is allowed to access. The list retained by the UE can be controlled by both the UE and an operator. The UE can have read and write permissions for the list. The list controlled by the UE and the operator can be referred to as an allowed CSG list. Further, the allowed CSG list can include CSG IDs and associated PLMN identities of the CSGs to which a subscriber belongs. Moreover, the allowed CSG list can include a Home Node B Name and/or a CSG Type; yet, the claimed subject matter is not so limited.

For example, as the network obtains information about which CSGs the UE is allowed to access, a network node (e.g., CSG list server, . . . ) can send a message to the UE instructing the UE to update the list. By way of illustration, an application level update can be employed to update the list stored by the UE. For example, the application level update can be managed by the operator using over-the-air (OTA) procedures or Open Mobile Alliance Device Management (OMA DM) procedures. Yet, it is to be appreciated that the claimed subject matter is not limited to the foregoing.

By way of illustration, a UE (e.g., UE 116, UE 122, . . . ) can be subscribed to a different PLMN (e.g., an HPLMN to which the UE is subscribed, . . . ) other than the PLMN associated with base station 102, and thus, the PLMN associated with base station 102 can be a VPLMN for the UE. The VPLMN can provide CSG membership to the UE without exchanging CSG specific information with the HPLMN. For example, the CSG membership can be acquired by the UE as a result of successful manual selection. By way of further example, the CSG membership granted to the UE during the stay in the VPLMN can be retained by the VPLMN in case the UE moves to another PLMN and subsequently returns to the VPLMN.

Wireless communication system 100 can support updating the list retained by the UE to support VPLMN-autonomous CSG roaming More particularly, a VPLMN can establish a trust relationship with the UE associated with a different PLMN. Further, the VPLMN can update a VPLMN allowed CSG list associated with the VPLMN stored by the UE. The VPLMN allowed CSG list can be a part of an allowed CSG list under control of at least one operator and the UE. Moreover, the VPLMN allowed CSG list can include one or more entries (e.g., CSG ID(s), . . . ) associated with the VPLMN. The UE can receive the VPLMN allowed CSG list, and can store the VPLMN allowed CSG list as part of the allowed CSG list at the UE to provision the UE in the VPLMN.

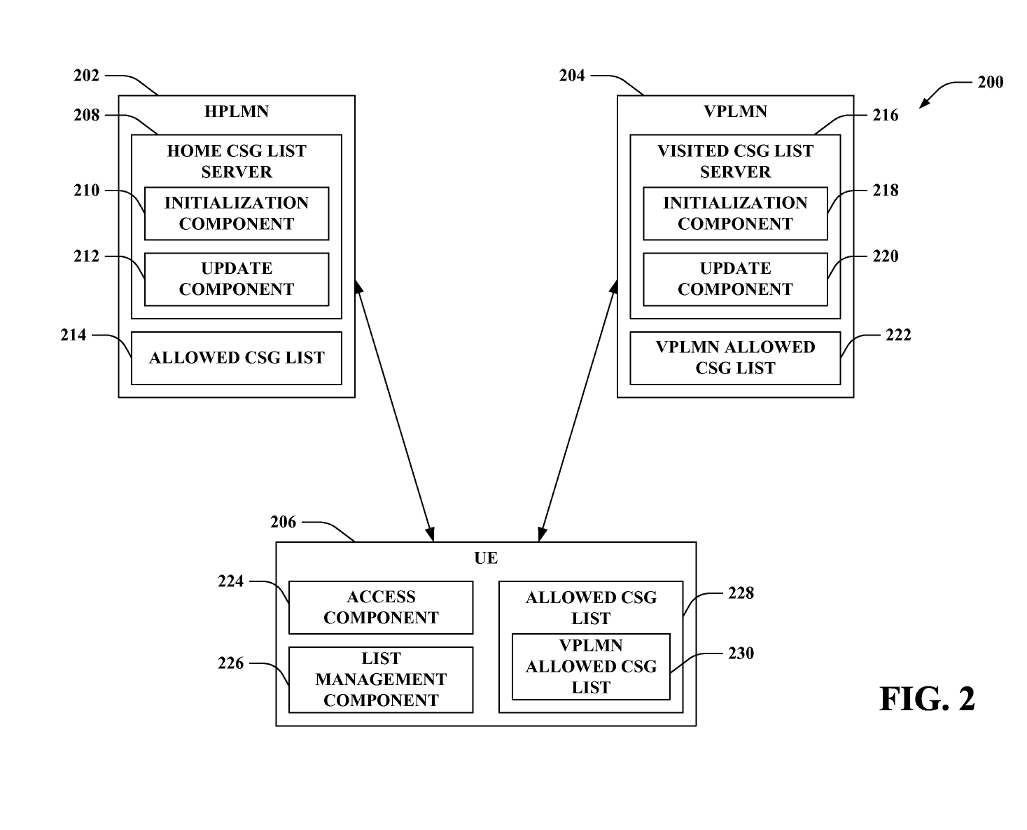

Referring to FIG. 2, illustrated is a system 200 that supports VPLMN- autonomous CSG roaming in a wireless communication environment. System 200 includes an HPLMN 202, a VPLMN 204, and a UE 206. Moreover, although not shown, it is contemplated that system 200 can further include any number of disparate UE(s), which can be substantially similar to UE 206. Further, although not shown, it is to be appreciated that system 200 can include any number of disparate VPLMN(s), which can be substantially similar to VPLMN 204.

HPLMN 202 can include a home CSG list server 208 that can host functions used by UE 206 to manage membership to different CSGs. Home CSG list server 208 can include an initialization component 210 and an update component 212. Moreover, HPLMN 202 can include an allowed CSG list 214. Initialization component 210 can establish a trust relation with UE 206 (e.g., upon access by UE 206, . . . ). Moreover, update component 212 can update a CSG subscription of UE 206 based on allowed CSG list 214 when UE 206 is attached in HPLMN 202 as established by initialization component 210. Thus, for example, home CSG list server 208 can provide UE CSG provisioning functions that manage an allowed CSG list 228 retained by UE 206 based on allowed CSG list 214 retained by HPLMN 202.

Moreover, VPLMN 204 can include a visited CSG list server 216 that similarly can host functions used by UE 206 to manage membership to different CSGs. Visited

CSG list server 216 can include an initialization component 218 and an update component 220. Further, VPLMN 204 can include a VPLMN allowed CSG list 222. Initialization component 218 can establish a trust relation with UE 206 (e.g., upon access by UE 206, . . . ). Moreover, update component 220 can update a CSG subscription of UE 206 based on VPLMN allowed CSG list 222 when UE 206 is attached in VPLMN 204 as established by initialization component 218. By way of example, visited CSG list server 216 can provide UE CSG provisioning functions that manage one or more CSG entries associated with VPLMN 204 (e.g., a VPLMN allowed CSG list 230, . . . ) included in allowed CSG list 228 retained by UE 206 based on VPLMN allowed CSG list 222 retained by VPLMN 204.

UE 206 can include an access component 224, a list management component 226, and allowed CSG list 228. Allowed CSG list 228 can further include VPLMN allowed CSG list 230. Although not shown, it is contemplated that allowed CSG list 228 can further include any number of disparate VPLMN allowed CSG list(s) associated with disparate VPLMN(s) (e.g., the disparate VPLMN allowed CSG list(s) can be substantially similar to VPLMN allowed CSG list 230, . . . ); however, the claimed subject matter is not so limited.

Access component 224 can access visited CSG list server 216 associated with VPLMN 204. Access component 224 can contact visited CSG list server 216 provided by VPLMN 204 to provision VPLMN allowed CSG list 230. For example, access component 224 can access visited CSG list server 216 associated with VPLMN 204 when UE 206 is connected to a base station (not shown) in VPLMN 204. By way of another example, access component 224 can access visited CSG list server 216 associated with VPLMN 204 when UE 206 is connected to a base station (not shown) in HPLMN 202.

Moreover, list management component 226 can receive VPLMN allowed CSG list 230 (e.g., based on VPLMN allowed CSG list 222, . . . ) from visited CSG list server 216 associated with VPLMN 204. List management component 226 can store VPLMN allowed CSG list 230 as part of allowed CSG list 228 to provision UE 206 in VPLMN 204. Further, list management component 226 can update an entry in allowed CSG list 228 for VPLMN 204 associated with visited CSG list server 216 upon receiving VPLMN allowed CSG list 230.

Although much of the following relates to UE 206 accessing visited CSG list server 216 to update VPLMN allowed CSG list 230, it is also contemplated that UE 206 can access home CSG list server 208, and thus, home CSG list server 208 of HPLMN 202 can update allowed CSG list 228. By way of example, access component 224 can access home CSG list server 208 associated with HPLMN 202. Home CSG list server 208 can be contacted by access component 224 to provision allowed CSG list 228. Moreover, list management component 226 can receive and store allowed CSG list 228 (e.g., based on allowed CSG list 214, . . . ) from home CSG list server 208 associated with HPLMN 202.

System 200 can support an application level update of allowed CSG list 228 (or a portion thereof such as VPLMN allowed CSG list 230). For instance, UE 206 (e.g., access component 224, . . . ) can contact visited CSG list server 216 provided by VPLMN 204 to provision VPLMN allowed CSG list 230, with one or more entries corresponding to VPLMN 204, using OMA DM procedures. Thus, update component 220 of visited CSG list server 216 can send VPLMN allowed CSG list 222 associated with VPLMN 204 to UE 206 using OMA DM procedures, and list management component 226 of UE 206 can receive VPLMN allowed CSG list 230 from visited CSG list server 216 associated with VPLMN 204 through OMA DM procedures.

According to an example, application level update can be supported in order to provision UE 206 with membership at a base station that operates in hybrid access mode (e.g., hybrid base station, . . . ). However, it is to be appreciated that the claimed subject matter is not so limited.

OMA DM can include two stages: bootstrap and Device Management (DM) provisioning. Bootstrap can relate to a process of provisioning a client (e.g., UE 206, . . . ) to a state where it is able to initiate a management session to a new server (e.g., visited CSG list server 216, . . . ). Further, DM provisioning can relate to a process by which a device (e.g., UE 206, . . . ) is provisioned by the server (e.g., visited CSG list server 216, . . . ) with further information after the device is bootstrapped. In the bootstrapping process, a trust relationship can be set between the client and the server; hence, UE 206 can be authenticated by visited CSG list server 216 in VPLMN 204 and vice versa.

Upon access component 224 accessing visited CSG list server 216, access component 224 of UE 206 and initialization component 218 of visited CSG list server 216 can establish a trust relationship. For example, the trust relationship can be established using generic bootstrapping architecture (GBA) procedures. The GBA procedures can include UE 206 (e.g., access component 224, . . . ) and a Bootstrapping Server Function (BSF) (e.g., network element in HPLMN 202, . . . ) mutually authenticating using the Authentication and Key Agreement (AKA) protocol, and agreeing on session keys. The session keys can then be applied between UE 206 (e.g., access component 224, . . . ) and an operator-controlled Network Application Function (NAF) (e.g., initialization component 218, . . . ) in VPLMN 204, which can be included in visited CSG list server 216 in VPLMN 204. UE 206 and visited CSG list server 216 can then run the rest of the bootstrap and provisioning procedures where authentication/encryption of messages can be based on the session keys generated during the mutual authentication between UE 206 and the BSF. Moreover, an identity of visited CSG list server 216 in VPLMN 204 can be determined by performing a Domain Name System (DNS) query based on a PLMN specific fully qualified domain name (FQDN).

Moreover, list management component 226 can protect allowed CSG list 228 from being overwritten by an unauthorized CSG list server. List management component 226 can select whether to update an entry in allowed CSG list 228 as a function of an identity of a CSG list server. For example, list management component 226 can make sure that visited CSG list server 216 in VPLMN 204 does not overwrite a CSG entry for a PLMN for which it is not authorized to update. The foregoing can be effectuated by list management component 226 accepting management data and commands received from visited CSG list server 216 to update VPLMN allowed CSG list 230 stored by UE 206 for VPLMN 204. Further, management data and commands received from visited CSG list server 216 to update one or more entries in allowed CSG list 228 stored by UE 206 for a PLMN other than VPLMN 204 can be rejected by list management component 226.

According to another example, home CSG list server 208 in HPLMN 202 can have access to entries in allowed CSG list 228 independent of PLMN. Thus, update component 212 can update an entry in allowed CSG list 228 for HPLMN 202 or a VPLMN (e.g., VPLMN 204, . . . ). Hence, an entry updated by update component 212 of HPLMN 202 can be included in VPLMN allowed CSG list 230. Further, list management component 226 can enable updating one or more entries from VPLMN allowed CSG list 230 associated with VPLMN 204 by accepting management data and commands received from home CSG list server 208 of HPLMN 202. Accordingly, one or more entries associated with VPLMN 204 in allowed CSG list 228 can be under control of UE 206, a visited operator associated with VPLMN 204, and a home operator. In contrast, one or more entries associated with a disparate PLMN other than VPLMN 204 in allowed CSG list 228 can be inhibited from being updated by a visited operator associated with VPLMN 204. By way of another example, home CSG list server 208 can be inhibited from updating an entry for a PLMN other than HPLMN 202; however, it is to be appreciated that the claimed subject matter is not so limited.

Pursuant to a further example, list management component 226 can manually update an entry in VPLMN allowed CSG list 230. For instance, if UE 206 manually selects a CSG in VPLMN 204 and is accepted, list management component 226 can add a CSG entry in VPLMN allowed CSG list 230 associated with VPLMN 204 (e.g., generally in allowed CSG list 228, . . . ). Allowed CSG list 228 can include placeholders for entries for another PLMN to support such manual update. It is to be appreciated, however, that the claimed subject matter is not limited to the foregoing example.

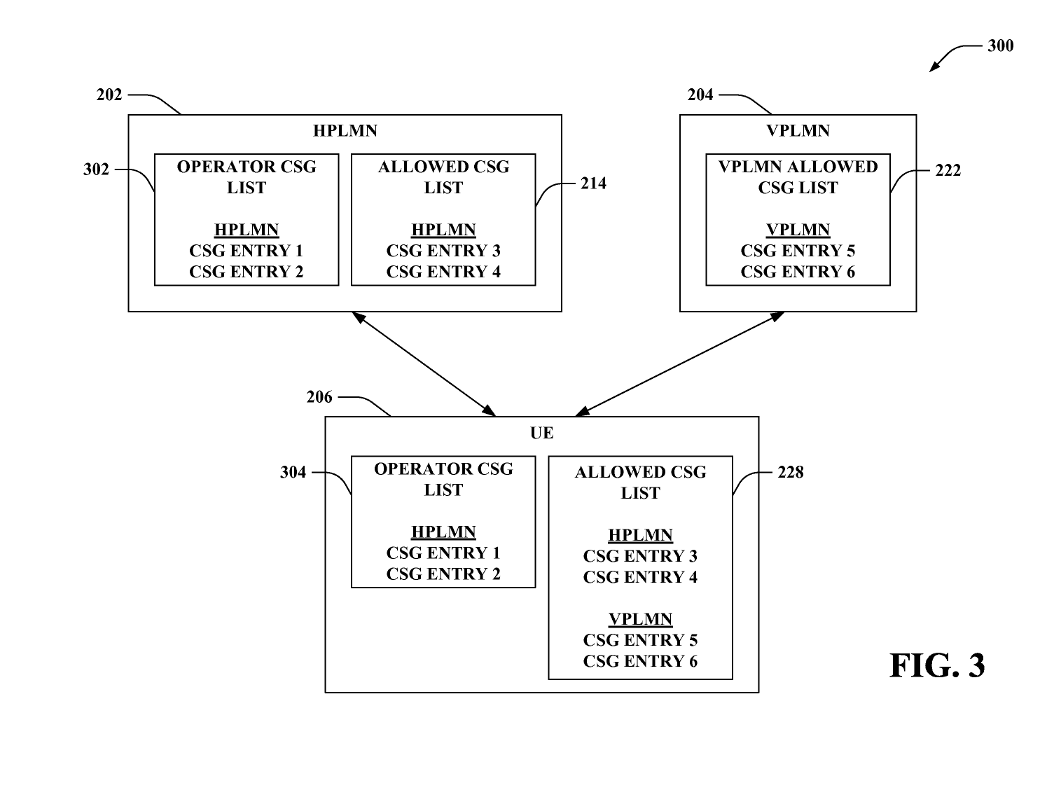

Now referring to FIG. 3, illustrated is a system 300 that provisions an allowed CSG list and an operator CSG list in a wireless communication environment that supports VPLMN-autonomous CSG roaming System 300 includes HPLMN 202, VPLMN 204, and UE 206. Although not shown, it is contemplated that HPLMN 202 can further include home CSG list server 208 of FIG. 2 and VPLMN 204 can further include visited CSG list server 216 of FIG. 2.

HPLMN 202 can retain allowed CSG list 214 and an operator CSG list 302. Moreover, VPLMN 204 can retain VPLMN allowed CSG list 222. Further, UE 206 can retain allowed CSG list 228 and an operator CSG list 304.

Operator CSG list 304 can be stored in UE 206, and can be under exclusive operator control (e.g., operator associated with HPLMN 202, . . . ). Operator CSG list 304 can include CSG IDs and/or associated PLMN identities of the CSGs to which a subscriber belongs. Operator CSG list 304, for example, can be stored in a Universal Subscriber Identity Module (USIM) (not shown) (or Subscriber Identity Module (SIM) (not shown)) of UE 206. However, it is further contemplated that operator CSG list 304 can be retained in any other type of memory (not shown) of UE 206. Memory can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the subject systems and methods is intended to comprise, without being limited to, these and any other suitable types of memory.

Operator CSG list 304 can be read only by UE 206. Further, operator CSG list 304 can be provisioned using OMA DM procedures or OTA procedures. For instance, OTA procedures can be utilized to provision operator CSG list 304 if UE 206 has a Release 9 USIM, while OMA DM procedures can be employed to provision operator CSG list 304 if UE 206 has a pre-Release 9 USIM. By way of another illustration, OTA procedures can be used to provision operator CSG list 304 if UE 206 has a Release 8 USIM, while OMA DM procedures can be utilized to provision operator CSG list 304 if UE 206 has a pre-Release 8 USIM. It is to be appreciated, however, that the claimed subject matter is not limited to the foregoing examples.

As mentioned above, operator CSG list 304 can be controlled by the operator associated with HPLMN 202. Thus, an operator in VPLMN 204 can be inhibited from updating operator CSG list 304. In the depicted example, operator CSG list 302 retained in HPLMN 202 can include CSG entry 1 and CSG entry 2. CSG entry 1 and CSG entry 2 can be associated with HPLMN 202. Further, a home CSG list server (e.g., home CSG list server 208 of FIG. 2, . . . ) can update operator CSG list 302 retained by UE 206 to include CSG entry 1 and CSG entry 2. Moreover, a visited CSG list server (e.g., visited CSG list server 216 of FIG. 2, . . . ) can be unable to alter an entry in operator CSG list 304 stored by UE 206.

According to the example shown in FIG. 3, allowed CSG list 214 retained by HPLMN 202 can include CSG entry 3 and CSG entry 4. CSG entry 3 and CSG entry 4 can be associated with HPLMN 202. Moreover, a home CSG list server (e.g., home CSG list server 208 of FIG. 2, . . . ) can update allowed CSG list 228 retained by UE 206 to include CSG entry 3 and CSG entry 4. Further, a visited CSG list server (e.g., visited CSG list server 216 of FIG. 2, . . . ) can be unable to alter an entry in allowed CSG list 228 corresponding to a PLMN other than VPLMN 204; hence, the visited CSG list server can be unable to update CSG entry 3 or CSG entry 4, which are associated with HPLMN 202 in the depicted example.

Moreover, VPLMN allowed CSG list 222 retained by VPLMN 204 can include CSG entry 5 and CSG entry 6. CSG entry 5 and CSG entry 6 can be associated with VPLMN 204. A visited CSG list server (e.g., visited CSG list server 216 of FIG. 2, . . . ) can update allowed CSG list 228 retained by UE 206 to include CSG entry 5 and CSG entry 6 associated with VPLMN 204. Moreover, CSG entry 5 and CSG entry 6 can form a portion of allowed CSG list 228 referred to as a VPLMN allowed CSG list (e.g., VPLMN allowed CSG list 230 of FIG. 2, . . . ). In the example shown in FIG. 3, a home CSG list server (e.g., home CSG list server 208 of FIG. 2, . . . ) can be unable to alter an entry in allowed CSG list 228 corresponding to VPLMN 204 (e.g., unable to update CSG entry 5 or CSG entry 6, . . . ); however, it is to be appreciated that the claimed subject matter is not limited to the example of FIG. 3.

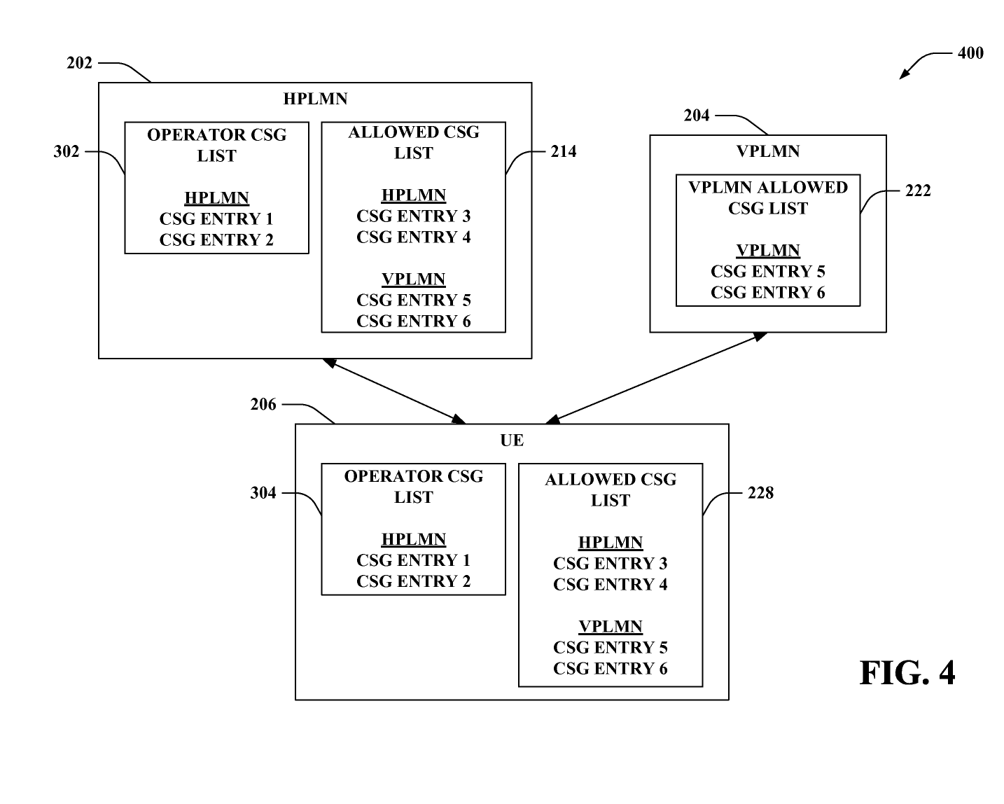

With reference to FIG. 4, illustrated is another system 400 that provisions an allowed CSG list and an operator CSG list in a wireless communication environment that supports VPLMN-autonomous CSG roaming In contrast to the example shown in FIG. 3, allowed CSG list 214 retained by HPLMN 202 can include one or more CSG entries associated with a disparate PLMN. More particularly, allowed CSG list 214 can include CSG entry 5 and CSG entry 6, where CSG entry 5 and CSG entry 6 can be associated with VPLMN 204. Further, a home CSG list server (e.g., home CSG list server 208 of FIG. 2, . . . ) can update allowed CSG list 228 retained by UE 206 to include CSG entry 5 and/or CSG entry 6. Following this example, CSG entry 5 and CSG entry 6 can be updated by an operator associated with HPLMN 202 and/or an operator associated with VPLMN 204 (and/or by UE 206).

According to an example, a network node of HPLMN 202 such as a home subscriber server (HSS)/home location register (HLR) can store CSG subscription data in HPLMN 202. The HSS/HLR in HPLMN 202 stores the CSG subscription data for HPLMN 202, and can store the CSG subscription data for VPLMN 204. The HSS/HLR can be aware of the CSG subscription data, but can be unaware of how the CSG subscription data is split between operator CSG list 302 and allowed CSG list 214. Yet, it is to be appreciated that the claimed subject matter is not so limited.

Moreover, a network node of a PLMN (e.g., HPLMN 202, VPLMN 204, . . . ) such as a mobility management entity (MME), a mobile switching center (MSC)/visitor location register (VLR), or a serving General Packet Radio Service (GPRS) support node (SGSN) can provide access control. Such network node that provides access control can be aware of CSG subscription information in that PLMN. By way of example, an MME in HPLMN 202 can be aware of CSG entry 1, CSG entry 2, CSG entry 3, and CSG entry 4, yet can be unaware of CSG entry 5 or CSG entry 6. Pursuant to a further example, an MME in VPLMN 204 can be aware of CSG entry 5 and CSG entry 6, but unaware of CSG entry 1, CSG entry 2, CSG entry 3, or CSG entry 4. It is to be appreciated, however, that the claimed subject matter is not limited to the foregoing examples.

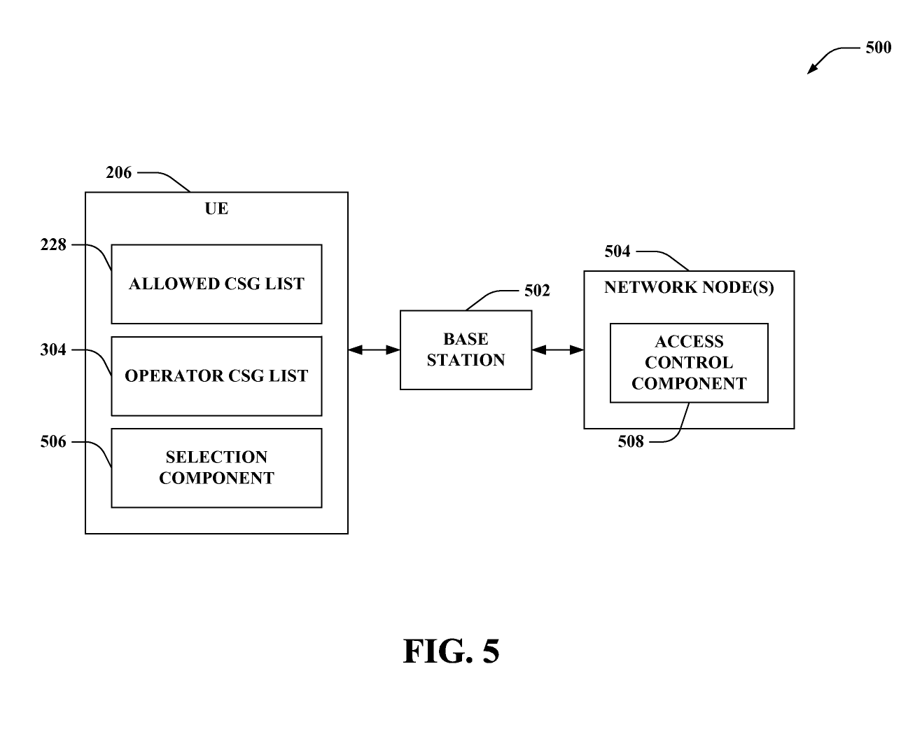

Turning to FIG. 5, illustrated is a system 500 that controls access in a wireless communication environment. System 500 includes UE 206 that can transmit and/or receive information, signals, data, instructions, commands, bits, symbols, and the like. Moreover, although not shown, system 500 can include any number of disparate UE(s), which can be substantially similar to UE 206. UE 206 can communicate with a base station 502 via the forward link and/or reverse link. Base station 502 can transmit and/or receive information, signals, data, instructions, commands, bits, symbols, and the like. Moreover, although not shown, it is contemplated that any number of base stations similar to base station 502 can be included in system 500. Further, it is contemplated that base station 502 can be any type of base station (e.g., femto cell base station, pico cell base station, micro cell base station, macro cell base station, . . . ).

According to an example, base station 502 can be a CSG base station, and thus, can operate in closed access mode. For instance, if base station 502 is a CSG base station, then base station 502 can be associated with a CSG, and the CSG can be identified by a CSG ID. The CSG can be uniquely identified by the CSG ID (e.g., globally, . . . ), for example. According to another example, the CSG can be uniquely identified by the CSG ID in an operator network. Further, base station 502 can advertise the CSG ID. Pursuant to another illustration, disparate base station(s) (not shown) included in system 500 can be CSG base station(s), hybrid base station(s), and/or open base station(s). Thus, system 500 can employ a mixed deployment of base stations where some base stations are hybrid and other base stations are CSG or open. Following this illustration, disparate base station(s) that are CSG base station(s) can be associated with respective CSG(s), and each of the respective CSG(s) can correspond to respective CSG ID(s).

Further, system 500 can include one or more network node(s) 504. For example, a Universal Terrestrial Radio Access Network (UTRAN) architecture for CSG provisioning and access control can be employed. Following this example, network node(s) 504 can include a MSC/VLR, a SGSN, a gateway GPRS support node (GGSN), a HSS/HLR, a policy and charging rule function (PCRF), and so forth. By way of another example, an Evolved Universal Terrestrial Radio Access Network (E-UTRAN) architecture for CSG provisioning and access control can be utilized. Pursuant to this example, network node(s) 504 can include a packet data network gateway (PGW), a serving gateway (SGW), a MME, a HSS/HLR, a PCRF, and the like. Moreover, although not shown, system 500 can include CSG provisioning elements such as, for instance, a CSG list server (e.g., home CSG list server 208 of FIG. 2, visited CSG list server 216 of FIG. 2, . . . ), a CSG administration server, etc. It is to be appreciated, however, that the claimed subject matter is not limited to the foregoing example architectures.

UE 206 can include allowed CSG list 228 and operator CSG list 304. Allowed CSG list 228 and operator CSG list 304 can be updated as described herein. Further, UE 206 can include a selection component 506 that can automatically select to access a CSG cell (e.g., corresponding to base station 502, . . . ) associated with a CSG with a corresponding CSG ID included in allowed CSG list 228 and/or operator CSG list 304 of UE 206. Selection component 506 can implement manual or automatic selection (or reselection). When employing manual CSG selection, selection component 506 can search for available CSG cells (e.g., corresponding to base station 502, corresponding to disparate base station(s) (not shown), . . . ), irrespective of whether the CSG IDs corresponding to the available CSG cells are present or absent in allowed CSG list 228 and/or operator CSG list 304. Moreover, selection component 506 can detect a set of available CSG cells that are selectable (e.g., suitable or acceptable for access, . . . ), and can receive input that identifies a manually selected CSG cell chosen to be accessed by UE 206 from the set of available CSG cells.

According to an illustration, when searching for available CSG cell(s), selection component 506 can obtain an advertised CSG ID sent by base station 502 that identifies the CSG corresponding to base station 502 (e.g., as well as advertised CSG ID(s) of one or more disparate base stations, . . . ). Further, selection component 506 can obtain input pertaining to the manually selected CSG cell from the set of available CSG cells. For example, the input can be manually yielded by a user of UE 206. Following this example, selection component 506 can display a list of the available CSG cells in the set for selection (e.g., via a Graphical User Interface (GUI), . . . ), and can receive the input that identifies the manually selected CSG cell in response to the displayed list. Yet, the claimed subject matter is not so limited.

Selection component 506 can cause UE 206 to request to access base station 502 based upon either manual or automatic selection (or reselection). For example, UE 206 can send an attach request message, a detach request message, a tracking area update request message, a location area updating request message, a routing area update request message, or the like upon selecting to access a CSG cell (e.g., base station 502, . . . ) associated with a CSG with a corresponding CSG ID in allowed CSG list 228 and/or operator CSG list 304, as effectuated by selection component 506. Further, UE 206 can receive an accept message or a reject message in response to the attach request message, detach request message, tracking area update request message, location area updating request message, routing area update request message, or the like sent thereby.

When UE 206 requests to access base station 502, one or more of network node(s) 504 can evaluate whether UE 206 is authorized to access such base station 502. At least one of the one or more of network node(s) 504 that evaluate whether UE 206 is authorized to access base station 502 can include an access control component 508. By way of example, CSG subscription data can be permanently stored in a HSS/HLR, and retrieved by a MME, MSC/VLR, and/or SGSN for access control during an attach procedure, service request procedure, or tracking/location/routing area updating procedure. When UE 206 accesses a CSG cell (e.g., base station 502, . . . ), access control component 508 of a first one of network node(s) 504 (e.g., MME, SGSN, MSC, . . . ) can check that the CSG ID of the CSG cell corresponds to a CSG ID in the subscription data retrieved from a second one of network node(s) 504 (e.g., HSS/HLR, . . . ), and that an expiration time (if present) remains valid. Further, if the CSG ID is not present in the subscription data or a timer has expired, then access control component 508 of the first one of network node(s) 504 (e.g., MME, SGSN, MSC, . . . ) can send a reject message to UE 206 with an error code indicating that UE 206 is not authorized for this CSG (e.g., error code #25, . . . ). Thus, assuming that base station 502 is associated with a CSG cell, access control component 508 of network node(s) 504 can perform access control based on the CSG ID advertised by the CSG cell (e.g., base station 502, . . . ) and the CSG subscription data of UE 206 stored in the network.

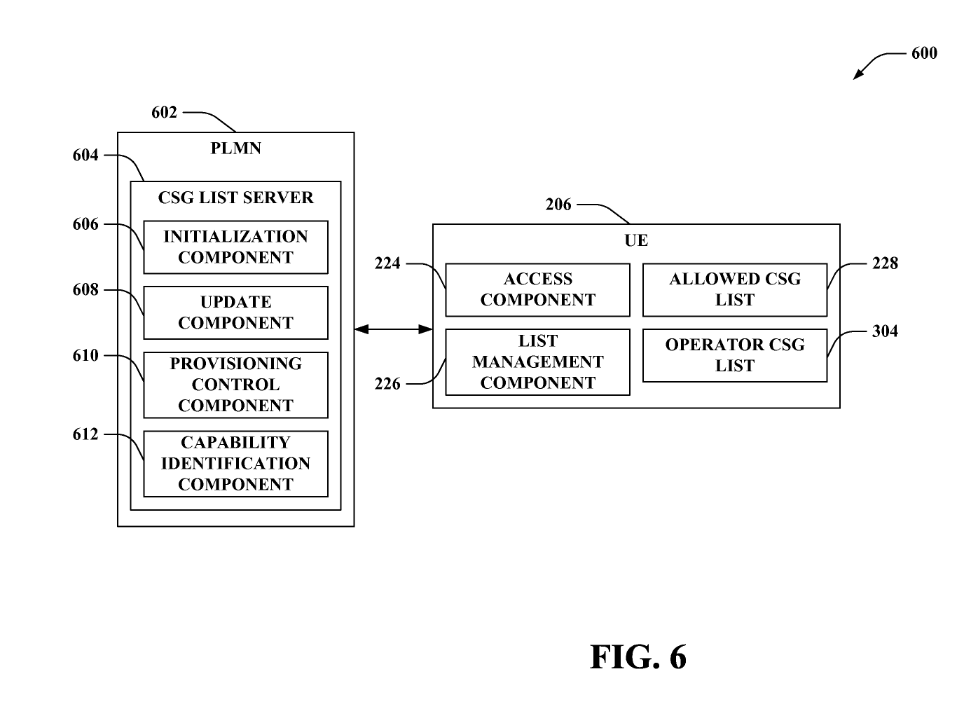

Referring now to FIG. 6, illustrated is a system 600 that manages CSG subscription data at a UE in a wireless communication environment. System 600 includes UE 206 and a PLMN 602 (e.g., HPLMN 202 of FIG. 2, VPLMN 204 of FIG. 2, . . . ). UE 206 can include access component 224 and list management component 226. Moreover, CSG subscription data can be included in allowed CSG list 228 and/or operator CSG list 304, which can be retained by UE 206.

PLMN 602 can further include a CSG list server 604 (e.g., home CSG list server 208 of FIG. 2, visited CSG list server 216 of FIG. 2, . . . ). CSG list server 604 can include an initialization component 606 (e.g., initialization component 210 of FIG. 2, initialization component 218 of FIG. 2, . . . ) and an update component 608 (e.g., update component 212 of FIG. 2, update component 220 of FIG. 2, . . . ). Moreover, CSG list server 604 can include a provisioning control component 610 and a capability identification component 612.

Update component 608 can update CSG subscription data retained by UE 206. Update component 608 can update operator CSG list 304 stored by UE 206 and/or allowed CSG list 228 stored by UE 206. Update component 608 can employ OMA DM procedures and/or OTA procedures to update operator CSG list 304 and/or allowed CSG list 228.

Moreover, provisioning control component 610 can manage which procedures (e.g., OMA DM procedures and/or OTA procedures, . . . ) can be utilized by update component 608 when updating operator CSG list 304 and/or allowed CSG list 228. According to an example, provisioning control component 610 can enable update component 608 to update operator CSG list 304 using OTA procedures, and can enable update component 608 to update allowed CSG list 228 using OMA DM procedures or OTA procedures. By way of another example, provisioning control component 610 can enable update component 608 to update operator CSG list 304 using OMA DM procedures or OTA procedures, and can enable update component 608 to update allowed CSG list 228 using OMA DM procedures or OTA procedures.

By way of example, when provisioning control component 610 permits update component 608 to use OTA procedures for updating operator CSG list 304, update component 608 can send an OTA transmission to UE 206 that updates operator CSG list 304. Following this example, the OTA transmission can be used to update operator CSG list 304 when operator CSG list 304 is stored on a USIM of UE 206.

Pursuant to a further example, when provisioning control component 610 permits update component 608 to use OMA DM procedures for updating operator CSG list 304, update component 608 can send an OMA DM transmission to UE 206 that update operator CSG list 304. In accordance with this example, the OMA DM transmission can be used to update operator CSG list 304 when operator CSG list 304 is stored on a Mobile Equipment (ME) of UE 206.

Moreover, capability identification component 612 can recognize a type of UE 206 and a type of a USIM (not shown) of UE 206. For instance, capability identification component 612 can identify whether UE 206 is an advanced UE (e.g., Release 9 UE, . . . ) or a legacy UE (e.g., Release 8 UE, pre-Release 9 UE, . . . ). Further, capability identification component 612 can identify whether the USIM of UE 206 is an advanced USIM (e.g., Release 9 USIM, . . . ) or a legacy USIM (e.g., Release 8 USIM, pre-Release 9 USIM, ...).

Based upon the recognized type of UE 206 and type of USIM of UE 206 as identified by capability identification component 612, provisioning control component 610 can select to update at least one of operator CSG list 304 or allowed CSG list 228. For example, provisioning control component 610 can select to update allowed CSG list 228 using OTA procedures or OMA DM procedures when the type of UE 206 is recognized by capability identification component 612 as being a legacy UE.

According to another example, provisioning control component 610 can select to update allowed CSG list 228 using OTA procedures or OMA DM procedures when the type of UE 206 is recognized by capability identification component 612 as being an advanced UE and the type of the USIM of UE 206 is recognized by capability identification component 612 as being a legacy USIM. Following this example, provisioning control component 610 can select to update operator CSG list 304 using OMA DM procedures when the type of UE 206 is recognized by capability identification component 612 as being an advanced UE and the type of the USIM of UE 206 is recognized by capability identification component 612 as being a legacy USIM.

Pursuant to a further example, provisioning control component 610 can select to update operator CSG list 304 using OTA procedures and allowed CSG list 228 using OTA procedures or OMA DM procedures when the type of UE 206 is recognized by capability identification component 612 as being an advanced UE and the type of the USIM of UE 206 is recognized by capability identification component 612 as being an advanced USIM. According to this example, operator CSG list 304 can be written to the USIM of UE 206.

In accordance with yet another example, provisioning control component 610 can select to update operator CSG list 304 using OMA DM procedures and allowed CSG list 228 using OTA procedures or OMA DM procedures when the type of UE 206 is recognized by capability identification component 612 as being an advanced UE and the type of the USIM of UE 206 is recognized by capability identification component 612 as being an advanced USIM. Following this example, operator CSG list 304 can be written to a ME of UE 206.

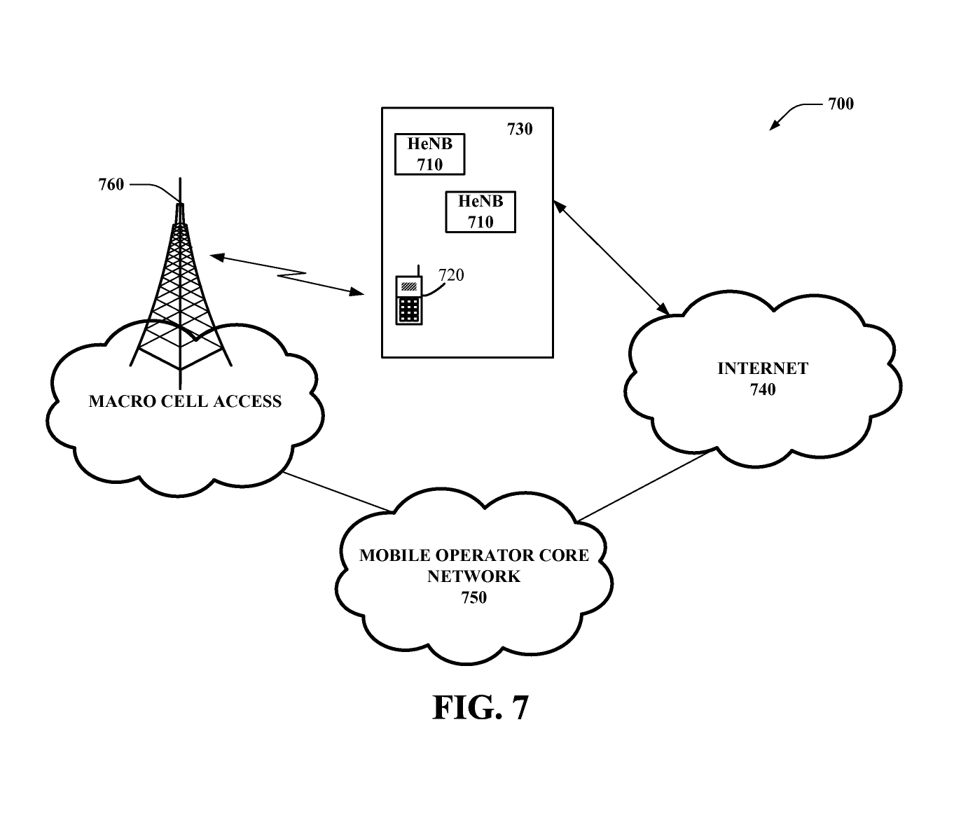

FIG. 7 illustrates an exemplary communication system 700 that enables deployment of access point base stations (e.g., femto cell base stations, . . . ) within a network environment. As shown in FIG. 7, system 700 includes multiple femto cell base stations, which can also be referred to as access point base stations, Home Evolved Node B units (HeNBs), Home Node B unit (HNB), femto cells, or the like. The femto cell base stations (HeNBs 710), for example, can each be installed in a corresponding small scale network environment, such as, for example, in one or more user residences 730, and can each be configured to serve associated, as well as alien, UE(s) 720. Each HeNB 710 is further coupled to the Internet 740 and a mobile operator core network 750 via a DSL router (not shown) or, alternatively, a cable modem (not shown).

Although embodiments described herein use 3GPP terminology, it is to be understood that the embodiments may be applied to 3GPP (Re199, Re15, Re16, Re17) technology, as well as 3GPP2 (1xRTT, 1xEV-DO Re10, RevA, RevB) technology and other known and related technologies. In such embodiments described herein, the owner of HeNB 710 can subscribe to mobile service, such as, for example, 3G mobile service, offered through the mobile operator core network 750, and UE 720 can be capable to operate both in a macro cellular environment via a macro cell base station 760 and in a residential small scale network environment. Thus, HeNB 710 can be backward compatible with any existing UE 720. It is contemplated that HeNBs 710 can include CSG HeNB(s), hybrid HeNB(s), and/or open HeNB(s).

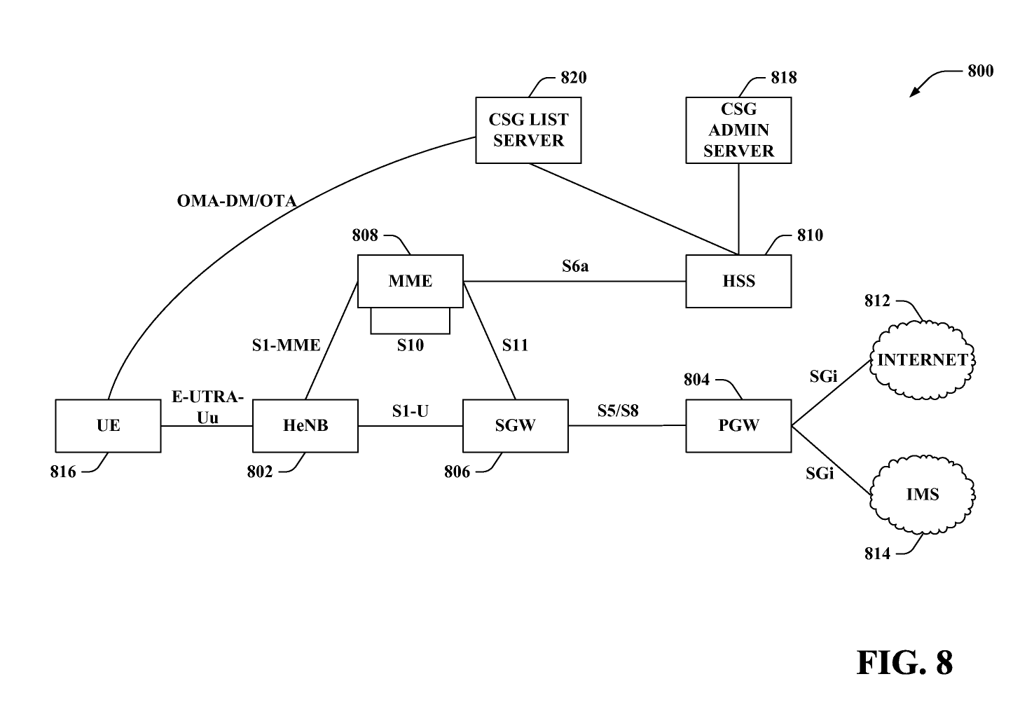

Now referring to FIG. 8, illustrated is an example system 800 that provides Closed Subscriber Group (CSG) support in a wireless communication environment. System 800 depicts an example architecture model that can be utilized in conjunction with an HeNB 802 (e.g., HeNBs 710 of FIG. 7, base station 502 of FIG. 5, . . . ). It is contemplated, however, that disparate architecture models are intended to fall within the scope of the hereto appended claims. For instance, although not shown, it is contemplated that differing architectures that support utilization of CSGs with a HNB, a macro cell base station, or any other type of base station is intended to fall within the scope of the claimed subject matter.

According to an illustration, HeNB 802 can be located on a user's premises; however, the claimed subject matter is not so limited. HeNB 802 can provide E- UTRAN eNB functions as well as functions to support HeNB authentication, HeNB registration, and HeNB configuration through Operation and Maintenance (OAM).

HeNB 802 can communicate directly or indirectly with various nodes (e.g., network node(s) 504 of FIG. 5, . . . ) of a core network (e.g., Evolved Packet Core (EPC), . . . ) in system 800. For instance, the nodes of the core network can include a PGW 804, a SGW 806, a MME 808, and a HSS 810. Although not shown, it is contemplated that system 800 can include more than one PGW 804, SGW 806, MME 808, and/or HSS 810.

PGW 804 can interface with external Packet Data Network(s) (PDN(s)) such as, for instance, the Internet 812 and/or an IP multimedia subsystem (IMS) 814. Moreover, although not depicted, PGW 804 can additionally or alternatively interface with an Intranet or any disparate PDN(s). PGW 804, for example, can handle address allocation, policy enforcement, packet classification and routing, and so forth.

SGW 806 is associated with a user plane and is an anchor point for mobility. SGW 806 points to a serving base station (e.g., HeNB 802, disparate HeNB, differing eNB, . . . ) of a user (e.g., employing a UE 816, . . . ). Thus, upon handing off to a differing base station, SGW 806 can repoint to the differing base station. Further, SGW 806 can enable data to be routed to the appropriate base station (e.g., HeNB 802, . . . ) serving UE 816 at a given time.

MME 808 is associated with a control plane. MME 808 can support control plane signaling for mobility, Quality of Service (QoS) initialization, user authentication, and the like. Further, HSS 810 can store various subscription information such as, for instance, phone numbers, profiles, and the like.

System 800 includes various interfaces between nodes. For instance, an S6a interface can connect MME 808 and HSS 810 and an S5/S8 interface can connect SGW 806 and PGW 804. Further, an S1-U interface can connect HeNB 802 and SGW 806, an S11 interface can couple SGW 806 and MME 808, and an S1-MME interface can connect HeNB 802 and MME 808. Additionally, PGW 804 can connect to PDN(s) (e.g., Internet 812, IMS 814, . . . ) via respective SGi interfaces, and HeNB 802 and UE 816 can be coupled via an E-UTRA-Uu interface. Moreover, MME 808 can be associated with an S10 interface to another MME (not shown).

HSS 810 can also directly or indirectly connect to CSG provisioning network elements, namely a CSG administration server 818 and a CSG list server 820. CSG administration server 818 can support CSG administration functions, which can be utilized to manage a list of subscribers for a CSG (e.g., access control list for the CSG,

For example, an owner of HeNB 802 can interact with CSG administration server 818 via an interface (e.g., GUI, website, . . . ) to add or remove a user from being included in a CSG associated with HeNB 802. Based upon such changes, CSG administration server 818 can update HSS 810 to adjust subscription information for the user as modified.

Further, CSG list server 820 provides UE CSG provisioning functionality utilized to manage a whitelist (WL) (e.g., allowed CSG list 228 of FIG. 2, operator CSG list 304 of FIG. 3, . . . ) for UE 816 (and/or any disparate UE(s) (not shown)). CSG list server 820 can inform UE 816 that it is a member of a particular group (e.g., particular CSG, . . . ). Further, when a subscription is updated by CSG administration server 818, HSS 810 can store subscription information corresponding to the update. Moreover, updating the subscription information in HSS 810 can trigger a message to be transferred to CSG list server 820, which can cause CSG list server 820 to utilize an OMA-DM process or OTA process to downlink the modified subscription information to UE 816. Hence, CSG list server 820 can enable coordinating the subscription information retained by HSS 810 and UE 816 (e.g., stored in memory of UE 816, retained on a Subscriber Identity Module (SIM) or a USIM associated with UE 816, . . . ).

Various logical network protocol functions between UE 816 and core network elements can be effectuated in system 800 to support CSG. The logical network protocol functions, for instance, can include UE CSG provisioning functions, access control functions, mobility management functions, and CSG administration functions.

UE CSG provisioning functions can manage the whitelist for UE 816. The whitelist is a list of CSG IDs; UE 816 is able to access CSG cells that have a CSG ID included in the whitelist. The whitelist can be stored in the network in order to perform access control and stored by UE 816 to enable selecting a cell to be accessed. The whitelist in the network can be permanently stored in HSS 810, and retrieved by MME 808 for access control during attach, detach, service request, and tracking area updating procedures. The whitelist at UE 816 can be stored on a USIM for such UE 816 or memory of UE 816.

Access control functions can ensure that a UE has a valid subscription at a CSG where it performs an access. MME 808 can perform access control for UE 816 accessing the network through an CSG cell during attach, detach, service request, and tracking area updating procedures. Further, MME 808 can include a reject cause value in a Non-Access Stratum (NAS) signaling response upon recognizing that UE 816 is not allowed in the CSG for attach, service request, and/or tracking area updating procedures.

Further, mobility management functions can be used to keep track of a current location of UE 816. The location of UE 816 in idle state can be known by the network on a Tracking Area list granularity. Thus, when in idle state, UE 816 can be paged in all cells of the Tracking Area list received at a last Tracking Area Update.

Moreover, CSG administration functions can manage the list of subscribers for a CSG. The CSG administration function can be hosted by an operator or a third party. For instance, a single list can control the HeNBs for a CSG. Further, HeNBs advertising the same CSG ID can have a single list of subscribers.

As noted above, HSS 810 can permanently retain CSG subscription information. Further, the CSG subscription information can be retrieved by MME 808 during an attach procedure or tracking area updating procedure as part of a subscription profile of UE 816. MME 808 can utilize the retrieved CSG subscription information to perform access control. For instance, MME 808 can perform access control since access control is a NAS level procedure, and MME 808 is the NAS endpoint in the core network. Further, MME 808 can obtain and store a copy of a whitelist for UE 816 (e.g., the whitelist can be retained as part of the user's subscription information, . . . ). Moreover,

MME 808 can know a CSG ID of a CSG cell where UE 816 is performing the access in order to effectuate access control.

Although described herein as being performed at the NAS, it is contemplated that access control for CSGs can be implemented at an Access Stratum (AS). Access control at the AS can be implemented in a Radio Network Controller (RNC) function in HeNB 802 (or in a related function in an HeNB-Gateway (not shown)). It is to be appreciated, however, that the claimed subject matter is not so limited.

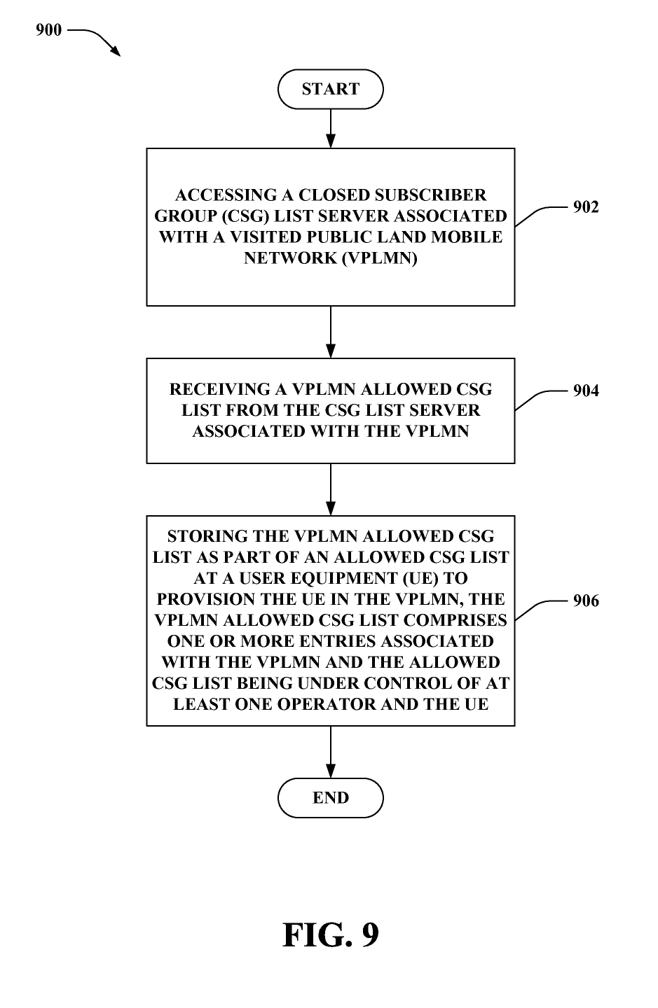

Referring to FIGS. 9-12, methodologies relating to supporting VPLMN- autonomous CSG roaming in a wireless communication environment are illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more embodiments.

Turning to FIG. 9, illustrated is a methodology 900 that facilitates collecting CSG subscription data in a wireless communication environment to provide VPLMN- autonomous CSG roaming support. At 902, a Closed Subscriber Group (CSG) list server associated with a Visited Public Land Mobile Network (VPLMN) can be accessed. For instance, the CSG list server associated with the VPLMN can be accessed when the UE is connected to a base station in the VPLMN. By way of another example, the CSG list server associated with the VPLMN can be accessed when the UE is connected to a base station in a Home Public Land Mobile Network (HPLMN). According to an illustration, the CSG list server associated with the VPLMN can be a visited CSG list server.

At 904, a VPLMN allowed CSG list can be received from the CSG list server associated with the VPLMN. The VPLMN allowed CSG list can be received from the CSG list served associated with the VPLMN through Open Mobile Alliance Device Management (OMA DM) procedures, for instance. Moreover, a trust relationship can be established with the CSG list server associated with the VPLMN. For instance, the trust relationship can be established with the CSG list server associated with the VPLMN using generic bootstrapping architecture (GBA) procedures. According to another example, the trust relationship can be established with the CSG list server associated with the VPLMN using a public-key cryptography standards (PKCS) certificate based mechanism. By way of a further example, a technique (e.g., GBA procedures, PKCS certificate based mechanism, . . . ) can be selected to be utilized for establishing the trust relationship with the CSG list server associated with the VPLMN through negotiation with the CSG list server.

At 906, the VPLMN allowed CSG list can be stored as part of an allowed CSG list at a user equipment (UE) to provision the UE in the VPLMN. The VPLMN allowed CSG list can comprise one or more entries associated with the VPLMN and the allowed CSG list can be under control of at least one operator and the UE. For instance, an entry in the allowed CSG list for the VPLMN associated with the CSG list server can be updated upon receiving the VPLMN allowed CSG list. The allowed CSG list, for example, can include a Public Land Mobile Network (PLMN) Identifier, a CSG Identifier, a Home Node B Name, a CSG Type, a combination thereof, and the like.

According to an example, an identity of the CSG list server associated with the VPLMN can be determined based upon a Public Land Mobile Network (PLMN) specific fully qualified domain name (FQDN). Moreover, the UE can select whether to update an entry in the allowed CSG list as a function of an identity of the CSG list server associated with the VPLMN.

By way of another example, a Home Public Land Mobile Network (HPLMN) can update an entry in the allowed CSG list for the VPLMN. Further, the one or more entries associated with the VPLMN in the allowed CSG list can be under control of the UE, a visited operator associated with the VPLMN, and a home operator. Moreover, a disparate one or more entries associated with a disparate Public Land Mobile Network (PLMN) other than the VPLMN in the allowed CSG list can be inhibited from being updated by a visited operator associated with the VPLMN.

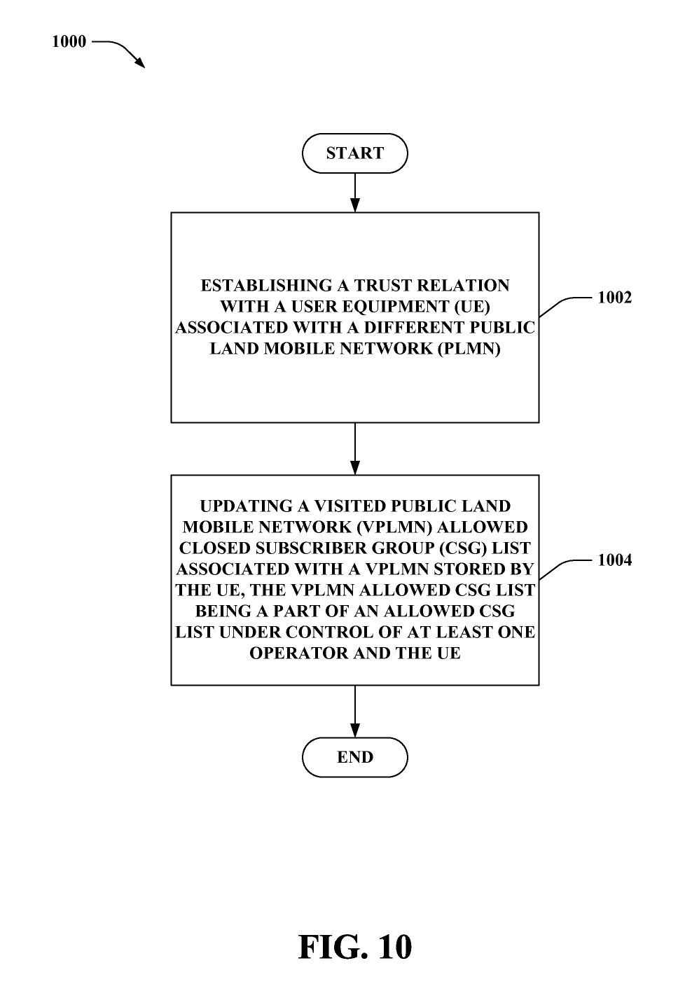

Now referring to FIG. 10, illustrated is a methodology 1000 that facilitates provisioning an allowed CSG list in a wireless communication environment to provide VPLMN-autonomous CSG roaming support. At 1002, a trust relation can be established with a user equipment (UE) associated with a different Public Land Mobile Network (PLMN). For example, the trust relation can be established with the UE when the UE is connected to a base station in the VPLMN. By way of another example, the trust relation can be established with the UE when the UE is connected to a base station in a Home Public Land Mobile Network (HPLMN). Pursuant to yet another example, the trust relation can be established with the UE using generic bootstrapping architecture (GBA) procedures. According to a further example, the trust relation can be established with the UE using a public-key cryptography standards (PKCS) certificate based mechanism. In accordance with yet another example, a technique (e.g., GBA procedures, PKCS certificate based mechanism, . . . ) can be selected to be utilized for establishing the trust relation with the UE through negotiation with the UE.

At 1004, a Visited Public Land Mobile Network (VPLMN) allowed Closed Subscriber Group (CSG) list associated with a VPLMN stored by the UE can be updated. The VPLMN allowed CSG list can be a part of an allowed CSG list under control of at least one operator and the UE. Moreover, the VPLMN allowed CSG list can comprise one or more entries associated with the VPLMN. For example, the VPLMN allowed CSG list associated with the VPLMN can be sent to the UE using Open Mobile Alliance Device Management (OMA DM) procedures. The allowed CSG list, for example, can include a Public Land Mobile Network (PLMN) Identifier, a CSG Identifier, a Home Node B Name, a CSG Type, a combination thereof, and the like.

Further, an entry in the allowed CSG list for the VPLMN can be updated. According to another example, a Home Public Land Mobile Network (HPLMN) can update an entry in the allowed CSG list for the VPLMN. Moreover, one or more entries associated with the VPLMN in the allowed CSG list can be under control of the UE, a visited operator associated with the VPLMN, and a home operator. According to another illustration, one or more entries associated with a disparate PLMN other than the VPLMN in the allowed CSG list can be inhibited from being updated by a visited operator associated with the VPLMN.

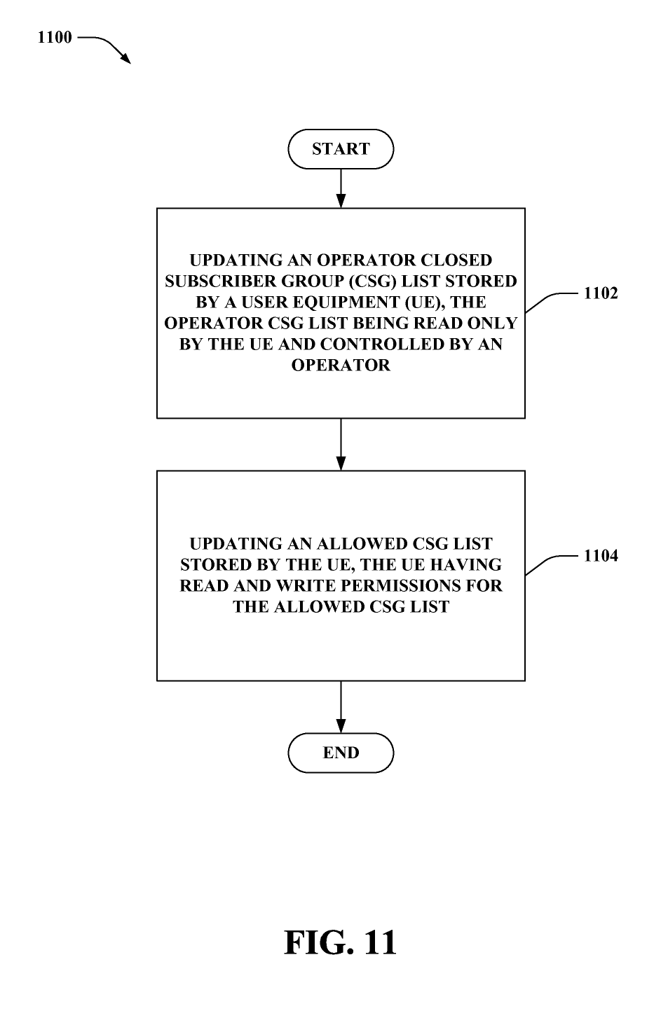

With reference to FIG. 11, illustrated is a methodology 1100 that facilitates provisioning CSG subscription data in a wireless communication environment. At 1102, an operator Closed Subscriber Group (CSG) list stored by a user equipment (UE) can be updated. The operator CSG list can be read only by the UE and controlled by an operator. At 1104, an allowed CSG list stored by the UE can be updated. The UE can have read and write permissions for the allowed CSG list.

According to an example, the operator CSG list can be updated using over-the- air (OTA) procedures. Following this example, the allowed CSG list can be updated using Open Mobile Alliance Device Management (OMA DM) procedures and/or the OTA procedures.

By way of another example, the operator CSG list can be updated using over- the-air (OTA) procedures and/or Open Mobile Alliance Device Management (OMA DM) procedures. Pursuant to this example, the allowed CSG list can be updated using the OMA DM procedures and/or the OTA procedures.

In accordance with another example, an OMA DM transmission can be sent to the UE that updates the operator CSG list stored on a Mobile Equipment (ME) of the UE. Pursuant to another example, the operator CSG list can be defined with an access condition that specifies that the operator CSG list is under control of an authority which created the operator CSG list. By way of a further example, the operator CSG list and/or the allowed CSG list can be updated to include one or more of a Public Land Mobile Network (PLMN) Identifier, a CSG Identifier, a Home Node B Name, and/or a CSG Type.

According to another example, a type of the UE and a type of a Universal Subscriber Identity Module (USIM) of the UE can be recognized. Further to this example, a selection to update at least one of the operator CSG list and the allowed CSG list can be effectuated as a function of the type of the UE and the type of the USIM. By way of illustration, the allowed CSG list can be selected to be updated using at least one of OTA procedures or OMA DM procedures when the type of the UE is recognized as being a legacy UE. Pursuant to another illustration, the allowed CSG list can be selected to be updated using at least one of OTA procedures or OMA DM procedures when the type of the UE is recognized as being an advanced UE and the type of the USIM of the UE is recognized as being a legacy USIM. Following this illustration, the operator CSG list can be selected to be updated using the OMA DM procedures when the type of the UE is recognized as being the advanced UE and the type of the USIM of the UE is recognized as being the legacy USIM. In accordance with yet another illustration, the operator CSG list can be selected to be updated using OTA procedures and the allowed CSG list can be selected to be updated using at least one of the OTA procedures or OMA DM procedures when the type of the UE is recognized as being an advanced UE and the type of the USIM of the UE is recognized as being an advanced USIM, where the operator CSG list can be written to the USIM of the UE. Pursuant to a further illustration, the operator CSG list can be selected to be updated using OMA DM procedures and the allowed CSG list can be selected to be updated using at least one of OTA procedures or the OMA DM procedures when the type of the UE is recognized as being an advanced UE and the type of the USIM of the UE is recognized as being an advanced USIM, where the operator CSG list can be written to a Mobile Equipment (ME) of the UE.

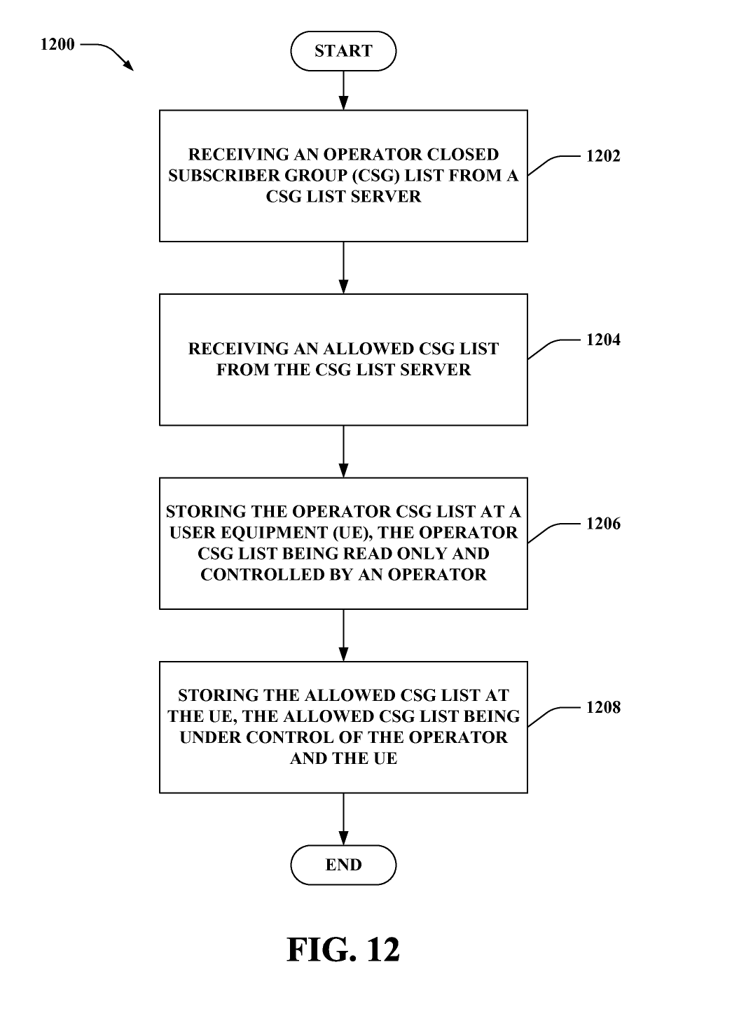

Referring to FIG. 12, illustrated is a methodology 1200 that facilitates retrieving CSG subscription data in a wireless communication environment. At 1202, an operator Closed Subscriber Group (CSG) list can be received from a CSG list server. At 1204, an allowed CSG list can be received from the CSG list server. At 1206, the operator CSG list can be stored at a user equipment (UE). The operator CSG list can be read only and controlled by an operator. Further, the operator CSG list can be defined with an access condition that specifies that the operator CSG list is under control of an authority which created the operator CSG list. At 1208, the allowed CSG list can be stored at the UE. The allowed CSG list can be under control of the operator and the UE. Moreover, the operator CSG list and/or the allowed CSG list can be updated to include or more of a Public Land Mobile Network (PLMN) Identifier, a CSG Identifier, a Home Node B Name, and/or a CSG Type.

According to an example, the operator CSG list can be received from the CSG list server through over-the-air (OTA) procedures. Following this example, the allowed CSG list can be received from the CSG list server through Open Mobile Alliance Device Management (OMA DM) procedures and/or the OTA procedures.

By way of another example, the operator CSG list can be received from the CSG list server through OTA procedures and/or OMA DM procedures, and the allowed CSG list can be received from the CSG list server through the OTA procedures and/or the OMA DM procedures.

For instance, the operator CSG list can be received from the CSG list server through OTA procedures, and the operator CSG list can be stored on a Universal Subscriber Identity Module (USIM) of the UE. By way of another illustration, the operator CSG list can be received from the CSG list server through OMA DM procedures, and the operator CSG list can be stored on a Mobile Equipment (ME) of the UE.

It will be appreciated that, in accordance with one or more aspects described herein, inferences can be made regarding provisioning CSG subscription data to support VPLMN-autonomous CSG roaming in a wireless communication environment. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

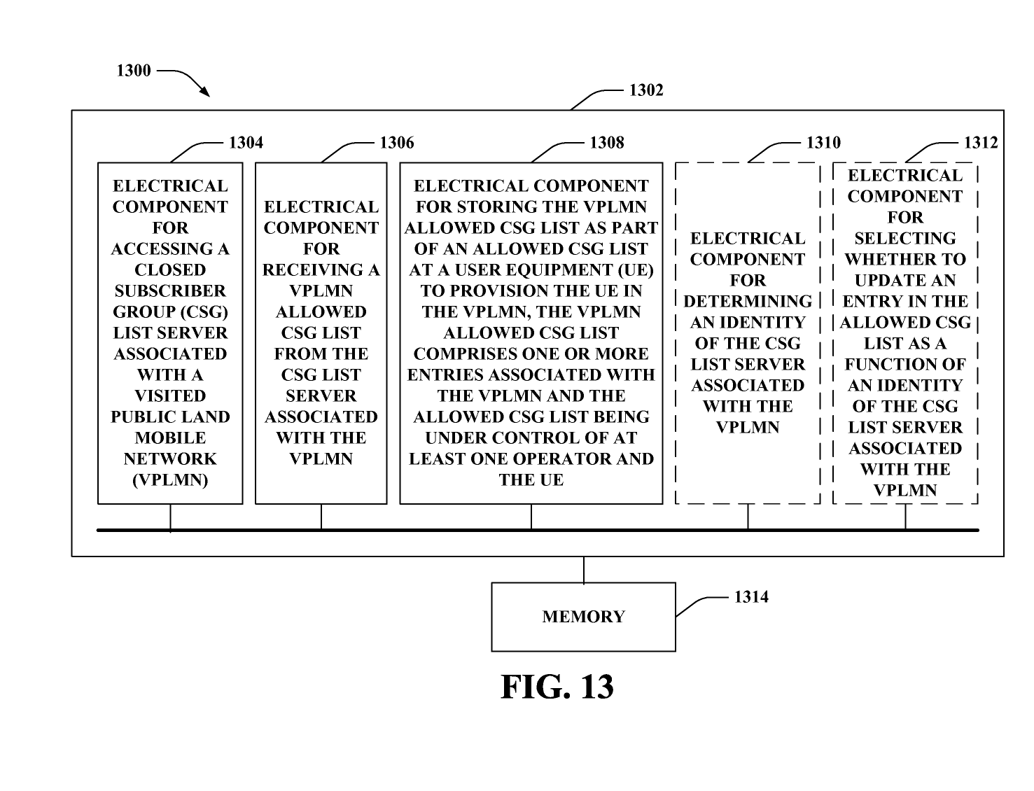

With reference to FIG. 13, illustrated is a system 1300 that enables obtaining CSG subscription data in a wireless communication environment. For example, system 1300 can reside within a UE. It is to be appreciated that system 1300 is represented as including functional blocks, which can be functional blocks that represent functions implemented by a processor, software, or combination thereof (e.g., firmware). System 1300 includes a logical grouping 1302 of electrical components that can act in conjunction. For instance, logical grouping 1302 can include an electrical component for accessing a Closed Subscriber Group (CSG) list server associated with a Visited Public Land Mobile Network (VPLMN) 1304. Further, logical grouping 1302 can include an electrical component for receiving a VPLMN allowed CSG list from the CSG list server associated with the VPLMN 1306. Moreover, logical grouping 1302 can include an electrical component for storing the VPLMN allowed CSG list as part of an allowed CSG list at a user equipment (UE) to provision the UE in the VPLMN, where the VPLMN allowed CSG list comprises one or more entries associated with the VPLMN and the allowed CSG list being under control of at least one operator and the UE 1308. Logical grouping 1302 can also optionally include an electrical component for determining an identity of the CSG list server associated with the VPLMN 1310. Additionally, logical grouping 1302 can optionally include an electrical component for selecting whether to update an entry in the allowed CSG list as a function of an identity of the CSG list server associated with the VPLMN 1312. Additionally, system 1300 can include a memory 1314 that retains instructions for executing functions associated with electrical components 1304, 1306, 1308, 1310, and 1312. While shown as being external to memory 1314, it is to be understood that one or more of electrical components 1304, 1306, 1308, 1310, and 1312 can exist within memory 1314.

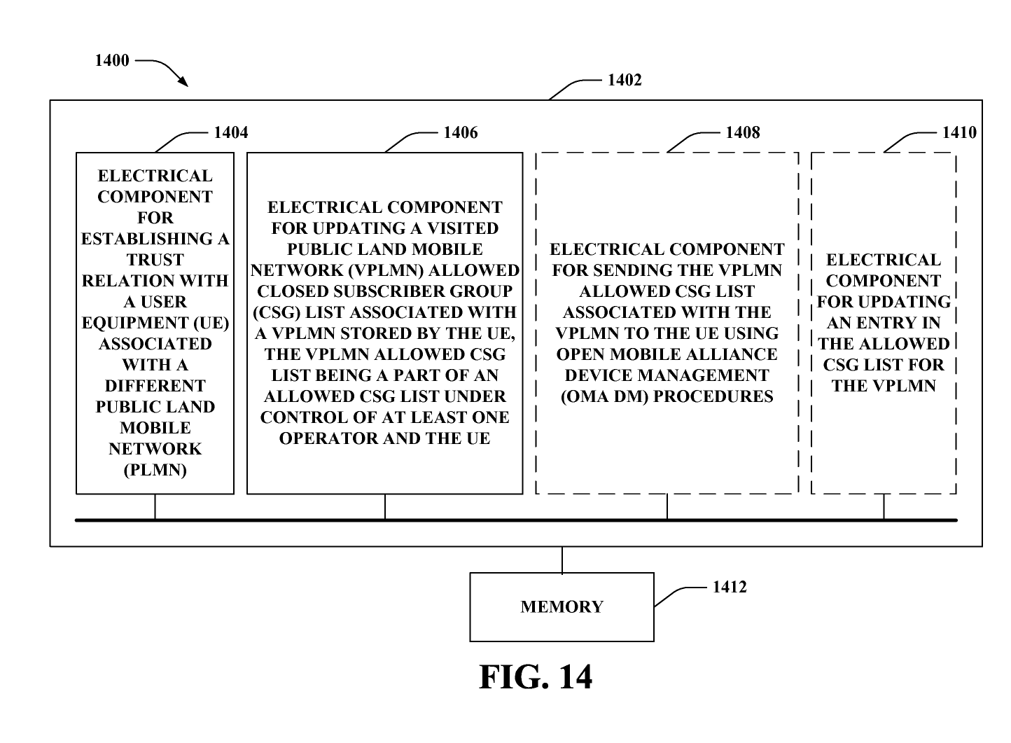

With reference to FIG. 14, illustrated is a system 1400 that enables provisioning CSG subscription data in a wireless communication environment. For example, system 1400 can reside at least partially within a CSG list server. It is to be appreciated that system 1400 is represented as including functional blocks, which can be functional blocks that represent functions implemented by a processor, software, or combination thereof (e.g., firmware). System 1400 includes a logical grouping 1402 of electrical components that can act in conjunction. For instance, logical grouping 1402 can include an electrical component for establishing a trust relation with a user equipment (UE) associated with a different Public Land Mobile Network (PLMN) 1404. Further, logical grouping 1402 can include an electrical component for updating a Visited Public Land Mobile Network (VPLMN) allowed Closed Subscriber Group (CSG) list associated with a VPLMN stored by the UE, the VPLMN allowed CSG list being a part of an allowed CSG list under control of at least one operator and the UE 1406. Logical grouping 1402 can also optionally include an electrical component for sending the VPLMN allowed CSG list associated with the VPLMN to the UE using Open Mobile Alliance Device Management (OMA DM) procedures 1408. Moreover, logical grouping 1402 can optionally include an electrical component for updating an entry in the allowed CSG list for the VPLMN 1410. Additionally, system 1400 can include a memory 1412 that retains instructions for executing functions associated with electrical components 1404, 1406, 1408, and 1410. While shown as being external to memory 1412, it is to be understood that one or more of electrical components 1404, 1406, 1408, and 1410 can exist within memory 1412.

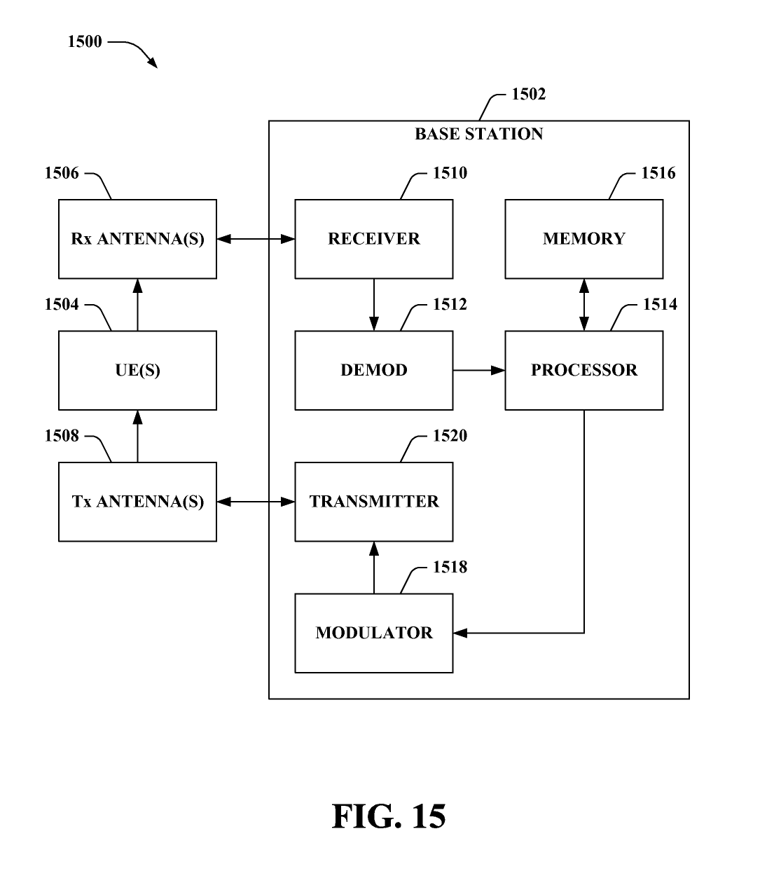

FIG. 15 is an illustration of a system 1500 that can be utilized to implement various aspects of the functionality described herein. System 1500 can include a base station 1502 (e.g., base station 502, . . . ). Base station 1502 can receive signal(s) from one or more UEs 1504 via one or more receive (Rx) antennas 1506 and transmit to the one or more UEs 1504 via one or more transmit (Tx) antennas 1508. Further, base station 1502 can include a receiver 1510 that receives information from receive antenna(s) 1506. According to an example, receiver 1510 can be operatively associated with a demodulator (demod) 1512 that demodulates received information. Demodulated symbols can be analyzed by a processor 1514. Processor 1514 can be coupled to memory 1516, which can store data to be transmitted to or received from UE(s) 1504 and/or any other suitable protocols, algorithms, information, etc. related to performing the various actions and functions set forth herein. Base station 1502 can further include a modulator 1518 that can multiplex a signal for transmission by a transmitter 1520 through antenna(s) 1508.

Processor 1514 can be a processor dedicated to analyzing information received by receiver 1510, dedicated to generating information for transmission by transmitter 1520, or dedicated to controlling one or more components of base station 1502. According to another example, processor 1514 can analyze information received by receiver 1510, generate information for transmission by transmitter 1520, and control one or more components of base station 1502. Moreover, although not shown, it is contemplated that the one or more components of base station 1502 can be part of processor 1514 or a plurality of processors (not shown).

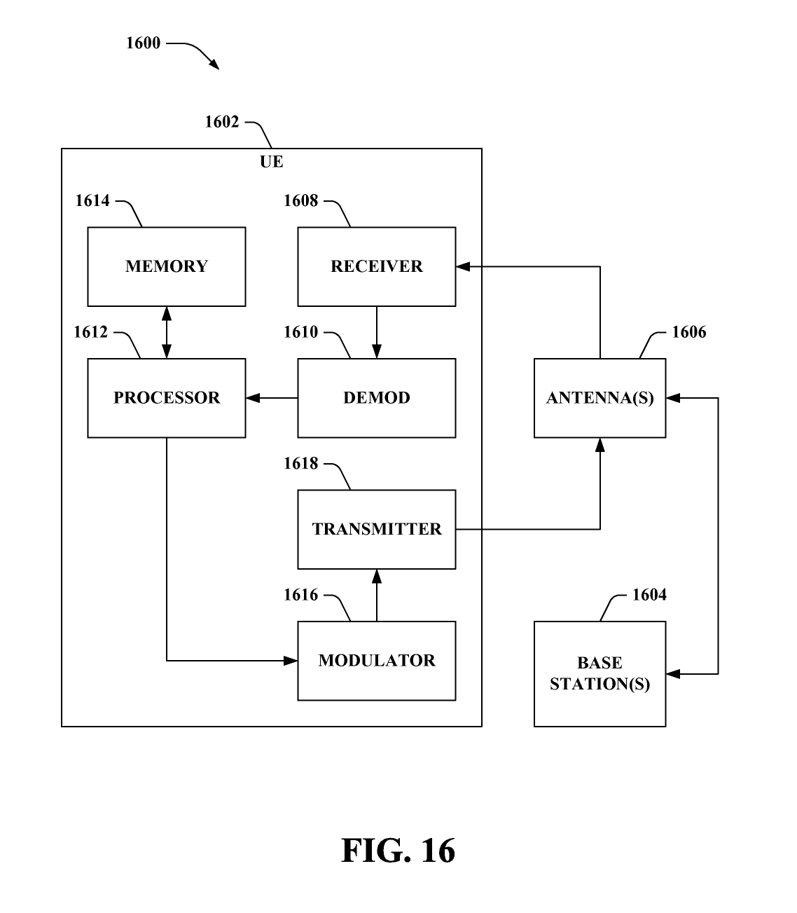

FIG. 16 is an illustration of a system 1600 that can be utilized to implement various aspects of the functionality described herein. System 1600 can include a UE 1602 (e.g., UE 206, . . . ). UE 1602 can receive signal(s) from one or more base stations 1604 and/or transmit to one or more base stations 1604 via one or more antennas 1606. Further, UE 1602 can include a receiver 1608 that receives information from antenna(s) 1606. According to an example, receiver 1608 can be operatively associated with a demodulator (demod) 1610 that demodulates received information. Demodulated symbols can be analyzed by a processor 1612. Processor 1612 can be coupled to memory 1614, which can store data to be transmitted to or received from base station(s) 1604 and/or any other suitable protocols, algorithms, information, etc. related to performing the various actions and functions set forth herein. For example, UE 1602 can employ processor 1612 to perform methodology 900, methodology 1200 and/or other similar and appropriate methodologies. UE 1602 can further include a modulator 1616 that can multiplex a signal for transmission by a transmitter 1618 through antenna(s) 1606.

Processor 1612 can be a processor dedicated to analyzing information received by receiver 1608, dedicated to generating information for transmission by transmitter 1618, or dedicated to controlling one or more components of UE 1602. According to another example, processor 1612 can analyze information received by receiver 1608, generate information for transmission by transmitter 1618, and control one or more components of UE 1602. The one or more components of UE 1602 can include, for example, access component 224, list management component 226, and/or selection component 506. Moreover, although not shown, it is contemplated that the one or more components of UE 1602 can be part of processor 1612 or a plurality of processors (not shown).

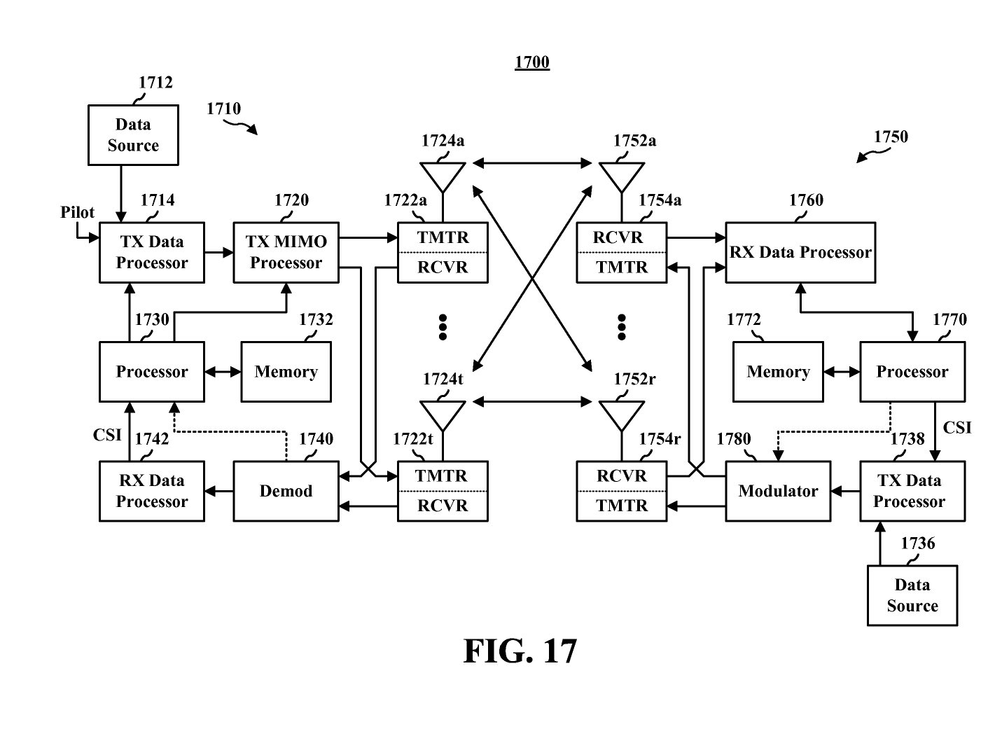

FIG. 17 shows an example wireless communication system 1700. Wireless communication system 1700 depicts one base station 1710 and one UE 1750 for sake of brevity. However, it is to be appreciated that system 1700 can include more than one base station and/or more than one UE, wherein additional base stations and/or UEs can be substantially similar or different from example base station 1710 and UE 1750 described below. In addition, it is to be appreciated that base station 1710 and/or UE 1750 can employ the systems (FIGS. 1-8 and 13-16) and/or methods (FIGS. 9-12) described herein to facilitate wireless communication there between.

At base station 1710, traffic data for a number of data streams is provided from a data source 1712 to a transmit (TX) data processor 1714. According to an example, each data stream can be transmitted over a respective antenna. TX data processor 1714 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at UE 1750 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1730.

The modulation symbols for the data streams can be provided to a TX MIMO processor 1720, which can further process the modulation symbols (e.g., for OFDM). TX MIMO processor 1720 then provides N_{T} modulation symbol streams to N_{T} transmitters (TMTR) 1722a through 1722t. In various embodiments, TX MIMO processor 1720 applies beamforming weights to the symbols of the data streams and to the antenna from which the symbol is being transmitted.

Each transmitter 1722 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 1722a through 1722t are transmitted from N_{T} antennas 1724a through 1724t, respectively.

At UE 1750, the transmitted modulated signals are received by N_{R} antennas 1752a through 1752r and the received signal from each antenna 1752 is provided to a respective receiver (RCVR) 1754a through 1754r. Each receiver 1754 conditions (e.g., filters, amplifies, and downconverts) a respective signal, digitizes the conditioned signal to provide samples, and further processes the samples to provide a corresponding “received” symbol stream.

An RX data processor 1760 can receive and process the N_{R} received symbol streams from N_{R} receivers 1754 based on a particular receiver processing technique to provide N_{T} “detected” symbol streams. RX data processor 1760 can demodulate, deinterleave, and decode each detected symbol stream to recover the traffic data for the data stream. The processing by RX data processor 1760 is complementary to that performed by TX MIMO processor 1720 and TX data processor 1714 at base station 1710.

A processor 1770 can periodically determine which available technology to utilize as discussed above. Further, processor 1770 can formulate a reverse link message comprising a matrix index portion and a rank value portion.

The reverse link message can comprise various types of information regarding the communication link and/or the received data stream. The reverse link message can be processed by a TX data processor 1738, which also receives traffic data for a number of data streams from a data source 1736, modulated by a modulator 1780, conditioned by transmitters 1754a through 1754r, and transmitted back to base station 1710.

At base station 1710, the modulated signals from UE 1750 are received by antennas 1724, conditioned by receivers 1722, demodulated by a demodulator 1740, and processed by a RX data processor 1742 to extract the reverse link message transmitted by UE 1750. Further, processor 1730 can process the extracted message to determine which precoding matrix to use for determining the beamforming weights.

Processors 1730 and 1770 can direct (e.g., control, coordinate, manage, etc.) operation at base station 1710 and UE 1750, respectively. Respective processors 1730 and 1770 can be associated with memory 1732 and 1772 that store program codes and data. Processors 1730 and 1770 can also perform computations to derive frequency and impulse response estimates for the uplink and downlink, respectively.

It is to be understood that the aspects described herein can be implemented in hardware, software, firmware, middleware, microcode, or any combination thereof For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

What has been described above includes examples of one or more embodiments. It is, of course, not possible to describe every conceivable combination of components or methodologies for purposes of describing the aforementioned aspects, but one of ordinary skill in the art can recognize that many further combinations and permutations of various aspects are possible. Accordingly, the described aspects are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method, comprising:
accessing a Closed Subscriber Group (CSG) list server associated with a Visited Public Land Mobile Network (VPLMN);
receiving a VPLMN allowed CSG list from the CSG list server associated with the VPLMN; and
storing the VPLMN allowed CSG list as part of an allowed CSG list at a user equipment (UE) to provision the UE in the VPLMN, the VPLMN allowed CSG list comprises one or more entries associated with the VPLMN and the allowed CSG list being under control of at least one operator and the UE.

2. The method of claim 1, further comprising accessing the CSG list server associated with the VPLMN when the UE is connected to a base station in the VPLMN.

3. The method of claim 1, further comprising accessing the CSG list server associated with the VPLMN when the UE is connected to a base station in a Home Public Land Mobile Network (HPLMN).

4. The method of claim 1, further comprising receiving the VPLMN allowed CSG list from the CSG list server associated with the VPLMN through Open Mobile Alliance Device Management (OMA DM) procedures.

5. The method of claim 1, further comprising establishing a trust relationship with the CSG list server associated with the VPLMN.

6. The method of claim 5, further comprising establishing the trust relationship with the CSG list server associated with the VPLMN using generic bootstrapping architecture (GBA) procedures.

7. The method of claim 5, further comprising establishing the trust relationship with the CSG list server associated with the VPLMN using a public-key cryptography standards (PKCS) certificate based mechanism.

8. The method of claim 5, further comprising selecting a technique to be utilized for establishing the trust relationship with the CSG list server associated with the VPLMN through negotiation with the CSG list server.

9. The method of claim 1, further comprising determining an identity of the CSG list server associated with the VPLMN based upon a Public Land Mobile Network (PLMN) specific fully qualified domain name (FQDN).

10. The method of claim 1, further comprising selecting whether to update an entry in the allowed CSG list as a function of an identity of the CSG list server associated with the VPLMN.

11. The method of claim 1, further comprising updating an entry in the allowed CSG list for the VPLMN associated with the CSG list server upon receiving the VPLMN allowed CSG list.

12. The method of claim 1, wherein a Home Public Land Mobile Network (HPLMN) updates an entry in the allowed CSG list for the VPLMN.

13. The method of claim 1, wherein the one or more entries associated with the VPLMN in the allowed CSG list are under control of the UE, a visited operator associated with the VPLMN, and a home operator.

14. The method of claim 1, wherein a disparate one or more entries associated with a disparate Public Land Mobile Network (PLMN) other than the VPLMN in the allowed CSG list are inhibited from being updated by a visited operator associated with the VPLMN.

15. The method of claim 1, wherein the allowed CSG list includes one or more of a Public Land Mobile Network (PLMN) Identifier, a CSG Identifier, a Home Node B Name, or a CSG Type.

16. A wireless communications apparatus, comprising:
at least one processor configured to:
access a Closed Subscriber Group (CSG) list server associated with a Visited Public Land Mobile Network (VPLMN);
receive a VPLMN allowed CSG list from the CSG list server associated with the VPLMN; and
store the VPLMN allowed CSG list as part of an allowed CSG list at a user equipment (UE) to provision the UE in the VPLMN, the VPLMN allowed CSG list comprises one or more entries associated with the VPLMN and the allowed CSG list being under control of at least one operator and the UE.

17. The wireless communications apparatus of claim 16, further comprising:
at least one processor configured to:
access the CSG list server associated with the VPLMN when the UE is connected to a base station in the VPLMN.

18. The wireless communications apparatus of claim 16, further comprising:
at least one processor configured to:
access the CSG list server associated with the VPLMN when the UE is connected to a base station in a Home Public Land Mobile Network (HPLMN).

19. The wireless communications apparatus of claim 16, further comprising:
at least one processor configured to:
receive the VPLMN allowed CSG list from the CSG list server associated with the VPLMN through Open Mobile Alliance Device Management (OMA DM) procedures.

20. The wireless communications apparatus of claim 16, further comprising:
at least one processor configured to:
establish a trust relationship with the CSG list server associated with the VPLMN.

21. The wireless communications apparatus of claim 20, further comprising:
at least one processor configured to:
establish the trust relationship with the CSG list server associated with the VPLMN using at least one of generic bootstrapping architecture (GBA) procedures or a public-key cryptography standards (PKCS) certificate based mechanism.

22. The wireless communications apparatus of claim 20, further comprising:
at least one processor configured to:
select a technique to be utilized for establishing the trust relationship with the CSG list server associated with the VPLMN through negotiation with the CSG list server.

23. The wireless communications apparatus of claim 16, further comprising:
at least one processor configured to:
determine an identity of the CSG list server associated with the VPLMN based upon a Public Land Mobile Network (PLMN) specific fully qualified domain name (FQDN).

24. The wireless communications apparatus of claim 16, further comprising:
at least one processor configured to:
select whether to update an entry in the allowed CSG list as a function of an identity of the CSG list server associated with the VPLMN.

25. The wireless communications apparatus of claim 16, further comprising:
at least one processor configured to:
update an entry in the allowed CSG list for the VPLMN associated with the CSG list server upon receiving the VPLMN allowed CSG list.

26. The wireless communications apparatus of claim 16, wherein a Home Public Land Mobile Network (HPLMN) updates an entry in the allowed CSG list for the VPLMN.

27. The wireless communications apparatus of claim 16, wherein the one or more entries associated with the VPLMN in the allowed CSG list are under control of the UE, a visited operator associated with the VPLMN, and a home operator.

28. The wireless communications apparatus of claim 16, wherein a disparate one or more entries associated with a disparate Public Land Mobile Network (PLMN) other than the VPLMN in the allowed CSG list are inhibited from being updated by a visited operator associated with the VPLMN.

29. An apparatus, comprising:
means for accessing a Closed Subscriber Group (CSG) list server associated with a Visited Public Land Mobile Network (VPLMN);
means for receiving a VPLMN allowed CSG list from the CSG list server associated with the VPLMN; and
means for storing the VPLMN allowed CSG list as part of an allowed CSG list at a user equipment (UE) to provision the UE in the VPLMN, the VPLMN allowed CSG list comprises one or more entries associated with the VPLMN and the allowed CSG list being under control of at least one operator and the UE.

30. The apparatus of claim 29, further comprising means for determining an identity of the CSG list server associated with the VPLMN.

31. The apparatus of claim 29, further comprising means for selecting whether to update an entry in the allowed CSG list as a function of an identity of the CSG list server associated with the VPLMN.

32. The apparatus of claim 29, wherein a Home Public Land Mobile Network (HPLMN) updates an entry in the allowed CSG list for the VPLMN.

33. The apparatus of claim 29, wherein the one or more entries associated with the VPLMN in the allowed CSG list are under control of the UE, a visited operator associated with the VPLMN, and a home operator.

34. The apparatus of claim 29, wherein a disparate one or more entries associated with a disparate Public Land Mobile Network (PLMN) other than the VPLMN in the allowed CSG list are inhibited from being updated by a visited operator associated with the VPLMN.

35. A computer program product, comprising:
a computer-readable medium comprising:
code for causing at least one computer to access a Closed Subscriber Group (CSG) list server associated with a Visited Public Land Mobile Network (VPLMN);
code for causing at least one computer to receive a VPLMN allowed CSG list from the CSG list server associated with the VPLMN; and
code for causing at least one computer to store the VPLMN allowed CSG list as part of an allowed CSG list at a user equipment (UE) to provision the UE in the VPLMN, the VPLMN allowed CSG list comprises one or more entries associated with the VPLMN and the allowed CSG list being under control of at least one operator and the UE.

36. The computer program product of claim 35, wherein the computer-readable medium further comprises code for causing at least one computer to determine an identity of the CSG list server associated with the VPLMN.

37. The computer program product of claim 35, wherein the computer-readable medium further comprises code for causing at least one computer to select whether to update an entry in the allowed CSG list as a function of an identity of the CSG list server associated with the VPLMN.

38. An apparatus, comprising:
an access component that accesses a Closed Subscriber Group (CSG) list server associated with a Visited Public Land Mobile Network (VPLMN); and
a list management component that receives a VPLMN allowed CSG list from the CSG list server associated with the VPLMN, and stores the VPLMN allowed CSG list as part of an allowed CSG list at a user equipment (UE) to provision the UE in the VPLMN, the VPLMN allowed CSG list comprises one or more entries associated with the VPLMN and the allowed CSG list being under control of at least one operator and the UE.

39. The apparatus of claim 38, the list management component selects whether to update an entry in the allowed CSG list as a function of an identity of the CSG list server associated with the VPLMN.

40. A method, comprising:
establishing a trust relation with a user equipment (UE) associated with a different Public Land Mobile Network (PLMN); and
updating a Visited Public Land Mobile Network (VPLMN) allowed Closed Subscriber Group (CSG) list associated with a VPLMN stored by the UE, the VPLMN allowed CSG list being a part of an allowed CSG list under control of at least one operator and the UE.

41. The method of claim 40, the VPLMN allowed CSG list comprises one or more entries associated with the VPLMN.

42. The method of claim 40, further comprising establishing the trust relation with the UE when the UE is connected to a base station in the VPLMN.

43. The method of claim 40, further comprising establishing the trust relation with the UE when the UE is connected to a base station in a Home Public Land Mobile Network (HPLMN).

44. The method of claim 40, further comprising sending the VPLMN allowed CSG list associated with the VPLMN to the UE using Open Mobile Alliance Device Management (OMA DM) procedures.

45. The method of claim 40, wherein the trust relation is established with the UE using generic bootstrapping architecture (GBA) procedures.

46. The method of claim 40, wherein the trust relation is established with the UE using a public-key cryptography standards (PKCS) certificate based mechanism.

47. The method of claim 40, further comprising selecting a technique to be utilized for establishing the trust relation with the UE through negotiation with the UE.

48. The method of claim 40, further comprising updating an entry in the allowed CSG list for the VPLMN.

49. The method of claim 40, wherein a Home Public Land Mobile Network (HPLMN) updates an entry in the allowed CSG list for the VPLMN.

50. The method of claim 40, wherein one or more entries associated with the VPLMN in the allowed CSG list are under control of the UE, a visited operator associated with the VPLMN, and a home operator.

51. The method of claim 40, wherein one or more entries associated with a disparate PLMN other than the VPLMN in the allowed CSG list are inhibited from being updated by a visited operator associated with the VPLMN.

52. The method of claim 40, wherein the allowed CSG list includes one or more of a PLMN Identifier, a CSG Identifier, a Home Node B Name, or a CSG Type.

53. A wireless communications apparatus, comprising:
at least one processor configured to:
establish a trust relation with a user equipment (UE) associated with a different Public Land Mobile Network (PLMN); and
update a Visited Public Land Mobile Network (VPLMN) allowed Closed Subscriber Group (CSG) list associated with a VPLMN stored by the UE, the VPLMN allowed CSG list being a part of an allowed CSG list under control of at least one operator and the UE.

54. The wireless communications apparatus of claim 53, further comprising:
at least one processor configured to:
send the VPLMN allowed CSG list associated with the VPLMN to the UE using Open Mobile Alliance Device Management (OMA DM) procedures.

55. The wireless communications apparatus of claim 53, further comprising:
at least one processor configured to:
update an entry in the allowed CSG list for the VPLMN.

56. The wireless communications apparatus of claim 53, wherein a Home Public Land Mobile Network (HPLMN) updates an entry in the allowed CSG list for the VPLMN.

57. The wireless communications apparatus of claim 53, wherein one or more entries associated with the VPLMN in the allowed CSG list are under control of the UE, a visited operator associated with the VPLMN, and a home operator.

58. The wireless communications apparatus of claim 53, wherein one or more entries associated with a disparate PLMN other than the VPLMN in the allowed CSG list are inhibited from being updated by a visited operator associated with the VPLMN.

59. An apparatus, comprising:
means for establishing a trust relation with a user equipment (UE) associated with a different Public Land Mobile Network (PLMN); and
means for updating a Visited Public Land Mobile Network (VPLMN) allowed Closed Subscriber Group (CSG) list associated with a VPLMN stored by the UE, the VPLMN allowed CSG list being a part of an allowed CSG list under control of at least one operator and the UE.

60. The apparatus of claim 59, further comprising means for sending the VPLMN allowed CSG list associated with the VPLMN to the UE using Open Mobile Alliance Device Management (OMA DM) procedures.

61. The apparatus of claim 59, further comprising means for updating an entry in the allowed CSG list for the VPLMN.

62. A computer program product, comprising:
a computer-readable medium comprising:
code for causing at least one computer to establish a trust relation with a user equipment (UE) associated with a different Public Land Mobile Network (PLMN); and
code for causing at least one computer to update a Visited Public Land Mobile Network (VPLMN) allowed Closed Subscriber Group (CSG) list associated with a VPLMN stored by the UE, the VPLMN allowed CSG list being a part of an allowed CSG list under control of at least one operator and the UE.

63. The computer program product of claim 62, wherein the computer-readable medium further comprises code for causing at least one computer to send the VPLMN allowed CSG list associated with the VPLMN to the UE using Open Mobile Alliance Device Management (OMA DM) procedures.

64. An apparatus, comprising:
an initialization component that establishes a trust relation with a user equipment (UE) associated with a different Public Land Mobile Network (PLMN); and
an update component that updates a Visited Public Land Mobile Network (VPLMN) allowed Closed Subscriber Group (CSG) list associated with a VPLMN stored by the UE, the VPLMN allowed CSG list being a part of an allowed CSG list under control of at least one operator and the UE.

65. The apparatus of claim 64, the update component sends the VPLMN allowed CSG list associated with the VPLMN to the UE using Open Mobile Alliance Device Management (OMA DM) procedures.
